(19) United States
(12) Patent Application Publication
(10) Pub. No.: US 2007/0092776 A1
(43) Pub. Date: Apr. 26, 2007

(54) Sulfonic acid group-containing organic-silica composite membrane and method for producing thereof

(75) Inventors: Eiichi Akiyama, Kanagawa (JP); Hitoshi Ito, Tokyo (JP); Hiroshi Yokota, Tokyo (JP)

Correspondence Address: BROWDY AND NEIMARK, P.L.L.C.;624 NINTH STREET, NW, SUITE 300, WASHINGTON, DC, 20001-5303, US

(73) Assignee: Ebara Corporation, Ohta-ku, Tokyo (JP)

(21) Appl. No.: 10/579,632

(22) PCT Filed: Nov. 17, 2004
(86) PCT No.: PCT/JP04/17432

§ 371 Date: May 17, 2006

(30) Foreign Application Priority Data
Nov. 18, 2003 (JP) 2003-388135

(51) Int. Cl. H01M 8/10; C08J 5/22; H01M 10/40

(52) U.S. Cl. 429/33; 521/27; 429/314

(57) ABSTRACT

Problems of the invention are to provide an organic-silica complex-type electrolyte membrane which is expected to show electrolyte properties such as sufficient ion conductivity to be used in an electrochemical device, to have sufficient thermal resistance and mechanical strength in accordance with applications, to contain no halogen element which exerts a large environmental load, to be capable of being produced at low cost and, further, in view of being used in the electrochemical device, to suppress swelling even when impregnated with water, alcohol, a non-protonic polar solvent, an auxiliary electrolyte solution or the like, and, accordingly, to be excellent in a joining property and adhesiveness against an electrode, a method for producing the electrolyte membrane and the electrochemical device using the electrolyte membrane. To solve the problems, a production method for an organic-silica complex membrane having a sulfonic acid group which is characterized by having the steps of obtaining a sulfonic acid derivative by allowing an alkoxysilane compound having an amino group to react with a cyclic sultone and subjecting the sulfonic acid derivative to a condensation reaction is used.

### TECHNICAL FIELD

The present invention relates to an organic-silica composite membrane to be advantageously used in various types of electrochemical devices such as an electric demineralization-type deionizer, a secondary battery, a fuel cell, a humidity sensor, an ion sensor, a gas sensor, an electrochromic device and a desiccant, various types of membrane transfer devices or membrane reaction devices such as a liquid separation membrane, a gas separation membrane, a membrane reaction apparatus and a membrane catalyst, and, further, an electrolyte membrane, an ion-exchanger, an ion conductor and a proton conductor which use the organic-silica composite membrane, and, still further, the production methods therefor, and, furthermore, an electrochemical device, a membrane transfer device or a membrane reaction device using any one of articles thus produced by using the organic-silica membrane.

### BACKGROUND ART

An electrolyte membrane, an ion-exchanger, an ion conductor or a proton conductor, which has been used in various types of electrochemical devices such as an electric demineralization-type deionizer, a secondary battery, a fuel cell, a humidity sensor, an ion sensor, a gas sensor, an electrochromic device and a desiccant, various types of membrane transfer devices or membrane reaction devices such as a liquid separation membrane, a gas separation membrane, a membrane reaction apparatus and a membrane catalyst, is one of members which give a largest influence on performances of these devices. As for an article which has widely been used as the ion-exchanger, polyvinylbenzene sulfonic acids represented by “DIAION®” (trade mark; available from Mitsubishi Chemical Corporation) has been known. These polyvinylbenzene sulfonic acids include such articles as can be obtained by radically polymerizing vinylbenzene sulfonic acid or a derivative of a vinylbenzene sulfonate and such articles as can be obtained by sulfonating a general-purpose polystyrene in a polymerization reaction. Since these polyvinylbenzene sulfonic acids are not only low in price and can easily control ion-exchange capacity, but also can freely select shapes such as a fibrous shape, a porous membrane shape and a bead shape, they have widely been used in the aforementioned technical field. Further, as for an ion conductive material, it has been known that polyethers represented by polyethylene oxide are useful. These polyethers can control viscosity by a molecular weight or the like and they have been applied in a polymer cell, various types of sensors and the like by making use of a metal ion conductivity to be generated by doping various types of metal salts thereinto. Further, a fluorine-type polymer electrolyte has been known as a chemically extremely stable electrolyte. The fluorine-type polymer electrolyte represented by NAFION® (trade mark; available from DuPont) has been utilized in a brine-electrolysis barrier membrane, a proton conductor membrane for a fuel cell and the like (for example, refer to JP-A-8-164319, JP-A-4-305219, JP-A-3-15175 and JP-A-1-253631).

Further, in recent years, from the standpoint of green chemistry, techniques for synthesizing/purifying a substance by an environmentally conscious process have been requested. In view of such request as described above, an in-vivo mass transfer/production system can be mentioned to be an ideal mode of a series of membrane transfer, membrane reaction, membrane separation, energy conversion techniques in which a substance is carried, synthesized and separated-purified via a membrane, to thereby take energy out. As for models of the in-vivo mass transfer/production system, for example, an article using an inorganic crystalline structure represented by zeolite is mentioned. Since it has a molecular-sized void in the structure and can specifically adsorb a specific molecule by controlling a size of the void, polarity of a circumference thereof or the like, an application thereof as a molecule-recognizing functional material is expected. Further, as an article having a molecule-recognizing performance similar to an in-vivo antigen-antibody reaction, a separation membrane of an optically active substance to be prepared by a molecular imprinting technique in which a mold molecule is removed from a polymer resin membrane mixed with the mold molecule has attracted people's attention. This technique replaces a technique which has been used for separating an isomer by passing a large amount of solvent through an expensive column for separating an optically isomeric substance and can efficiently separate only the necessary substance.

Incidentally, a sol-gel technique has widely been known as a technique for obtaining an inorganic substance by firstly hydrolyzing a metal alkoxide such as an alkoxysilane and, then, gelling the resultant hydrolysate by a condensation reaction. Further, the sol-gel technique has particularly attracted people's attention in recent years as a convenient technique for synthesizing an organic-inorganic complex concurrently having advantages of an inorganic material such as thermal resistance and advantages of an organic material such as capability of provision of various types of functions, improvement of brittleness and realization of a thin film. Still further, applications of the sol-gel technique to alkoxysilane derivatives having various types of functional groups have been known to date (for example, Toshio Imai, “Fundamental Section”, Chap. 6 of Hideki Sakurai ed. “New Development of Organic Silicon Polymer”, CMC Publishing Co., 1996, and Douglas A. Loy et al., “Chemistry of Materials”, vol. 12, pp. 3624 to 3632, 2000.). Furthermore, when the sol-gel technique is used, the hydrolysis and condensation reaction are progressed in a competing manner with each other and a reaction process becomes complicated; therefore, it ordinarily gives no single final product (the reaction process of the sol-gel technique being described in detail in Sumio Sakka, “Science of Sol-Gel Techniques”, Chap. 9, Agne Shofusha, 1988.).

### DISCLOSURE OF THE INVENTION

Incidentally, as described above, since the polyvinylbenzene sulfonic acids are not only low in price and can easily control ion-exchange capacity, but also can freely select shapes such as a fibrous shape, a porous membrane shape and a bead shape, a wide application can be expected for them. Whereas, when a density of a sulfonic acid group thereof is increased, they become water-soluble and, then, in order to stabilize the shapes thereof in water, a cross-linkable monomer such as divinylbenzene must be simultaneously used. However, as a radical polymerization reaction which is a chain reaction is progressed, a polymerized article becomes insoluble to a solvent and, then, while it is easy to obtain the polymerized article as a swelled body in gel form or powder in bead form, it is difficult to form it into a sheet in mesh form or a uniform thin film.

On the other hand, when an electron beam induced graft polymerization method or the like is used, it is possible to chemically combine polystyrene on a surface of a polymeric base material in a shape suitable for an application and, by subjecting the resultant article further to sulfonation, it is possible to relatively easily obtain a graft polymer in a cloth shape, a porous shape or a film shape. However, since a sulfonation reaction is an electrophilic substitution reaction, the polymeric base material which can be used is limited to polyolefin-type resins such as polyethylene, and these resins are not always sufficient for an application which requires thermal resistance, mechanical strength and the like.

Further, although polyethers are excellent in ion conductivity and the like, since they are ordinarily in gel form, they can not be used in an application which requires mechanical strength.

Still further, although a fluorine-type polymer electrolyte is excellent in chemical resistance and the mechanical strength, it is necessary to use a halogen-type organic solvent having a high affinity with a fluorine-type compound in a production process. In recent years, an influence of the halogen-type compound to the environment has become a social concern and, then, it is necessary to pay attention to avoid any leakage of the halogen-type compound to the environment in the production process, or a discharge of a toxic halogen-containing compound at the time of incineration and the like in the waste disposal process to be performed after the product is used. Under these circumstances, it is desirable to use a non-halogen-type compound which exerts a small environmental load.

On the other hand, a crystalline body, containing a void of a molecular size formed by condensation of various types of inorganic hydroxides, which is ordinarily called as zeolite, or an amorphous silica porous body having SiO₂ as a major constitutional component is expected to find applications in a selectively adsorbing agent, a selectively permeable separation membrane and the like making use of a property of easily adsorbing a specified molecule in a pore. Further, a catalytic action and the like are expected by allowing a specified metallic species such as titanium to be contained therein and, then, applications in a membrane reactor and the like are under study. However, it is a present situation that such inorganic structures are ordinarily obtained only in powder form. In recent years, although self-sustaining zeolite membranes have been obtained by allowing a fine crystal to be deposited in film form at the time of condensation of the inorganic hydroxide, these membranes have no flexibility and are mechanically brittle and, accordingly, it is hard to mention that they are practical membrane materials. Further, in the separation membrane having the molecule-recognizing performance applied with the molecular imprinting technique, in order to form a recognition site of a molecular size, a dense membrane constitution is ordinarily required. For this account, when it is intended to enhance such recognition performance, diffusion of a substance in the membrane and, then, membrane permeability of the substance is remarkably impeded and, accordingly, a practical permeability speed can not be obtained. On the other hand, when an affinity to a medium is enhanced aiming at enhancing the permeability, there is a problem in that, for example, the molecule-recognizing performance is deteriorated due to swelling and the like.

Further, as for the organic-inorganic complex which has so far been synthesized by using the sol-gel technique, there were a large number of articles which had a relatively simple structure such that a functional group was a group having a hydrogen atom at a terminal thereof, an alkyl group of, for example, an alcohol or a thiol, or a substituted phenyl group. The reason why these functional groups which were able to be introduced were limited was because the alkoxysilane was easily hydrolyzed and, accordingly, it was conventionally difficult to introduce an ion-exchangeable substituent.

An object according to the present invention is to provide an organic-silica complex-type electrolyte membrane which is expected to show electrolyte properties such as sufficient ion conductivity to be used in an electrochemical device, to have sufficient thermal resistance and mechanical strength, to contain no halogen element which exerts a large environmental load, to be capable of being produced at low cost and, further, in view of being used in the electrochemical device, to suppress swelling even when impregnated with water, alcohol, a non-protonic polar solvent, an auxiliary electrolyte solution or the like, and, accordingly, to be excellent in a joining property and adhesiveness with an electrode, a method for producing the electrolyte membrane and the electrochemical device using the electrolyte membrane. In addition, another object according to the present invention is to provide an organic-silica complex member having a sulfonic acid group which is expected to be capable of being made to be a soft and tenacious membrane, to suppress swelling of the membrane due to a three-dimensionally cross-linked structure, regardless of having a hydrophilic sulfonic acid group, and to suppress deterioration of the permeability speed of a substance while maintaining the molecule-recognizing performance or a catalytic activity by allowing zeolites and inorganic powders having molecule-recognizing performance or reaction catalytic performance to be fixed in the membrane and using an appropriate organic component, a method for producing the complex membrane, and a membrane transfer device using the complex membrane or a membrane reaction device.

The present inventors have exerted intensive studies in order to solve the aforementioned problems and, as a result, have found that the aforementioned problems can be solved by allowing an alkoxysilane compound having an amine residue to react with a cyclic sultone and the present invention has been accomplished on the basis of such finding. Namely, a sulfonic acid group is a functional group which is expected to function as a hydrophilic group, an acid (ionic) dissociation group in an electrolyte, an adsorption site of a basic substance or an acid catalyst and, in order to fix it in a silica matrix, the alkoxysilane compound having an amine residue is allowed to react with the cyclic sultone to produce a sulfonic acid group and, then, a condensation reaction, namely, a sol-gel process of the alkoxysilane is progressed by the thus-produced self-sulfonic acid group, to thereby provide an organic-silica complex membrane having a sulfonic acid group.

Namely, the present invention relates to a production method for an organic-silica complex membrane having a sulfonic acid group, being characterized by comprising the steps of:

obtaining a sulfonic acid derivative by allowing an alkoxysilane compound having an amino group to react with a cyclic sultone; and

subjecting the sulfonic acid derivative to a condensation reaction.

Further, the present invention relates to a production method for an organic-silica complex membrane having a sulfonic acid group, being characterized by comprising the steps of:

obtaining a sulfonic acid derivative by allowing a secondary or tertiary amine derivative which is obtained by allowing an alkoxysilane compound having an amino group to react with a compound having at least 2 epoxy groups in a molecule to react with a cyclic sultone; and

subjecting the sulfonic acid derivative to a condensation reaction.

Further, the present invention relates to a production method for an organic-silica complex membrane having a sulfonic acid group, being characterized by comprising the steps of:

obtaining a sulfonic acid derivative by allowing a secondary or tertiary amine derivative which is obtained by allowing an alkoxysilane compound having an epoxy group to react with an amine compound having at least 2 amine valences (number of active hydrogen atoms originated in an amino group contained in one molecule) to react with a cyclic sultone; and

subjecting the sulfonic acid derivative to a condensation reaction.

Further, the present invention relates to a production method for an organic-silica complex membrane having a sulfonic acid group, being characterized by comprising the steps of:

obtaining a sulfonic acid derivative by allowing a secondary or tertiary amine derivative which is obtained by allowing an alkoxysilane compound having an amino group to react with an alkoxysilane compound having an epoxy group to react with a cyclic sultone; and

subjecting the sulfonic acid derivative to a condensation reaction.

Further, the present invention relates to a production method for an organic-silica complex membrane having a sulfonic acid group, being characterized in that a condensation reaction of an alkoxysilane portion of the sulfonic acid derivative is progressed by a catalytic action of a self-sulfonic acid group of a sulfonic acid derivative generated by allowing to react with a cyclic sultone.

Further, the present invention relates to the production method for the organic-silica complex membrane having the sulfonic acid group, being characterized in that the step for obtaining the sulfonic acid derivative and the condensation reaction step are simultaneously progressed.

Further, the present invention relates to the production method for the organic-silica complex membrane having the sulfonic acid group, being characterized in that the condensation reaction step is performed in the presence of a metal alkoxide having no reactivity with an epoxy group and an amino group.

Further, the present invention relates to the production method for the organic-silica complex membrane having the sulfonic acid group, being characterized in that the condensation reaction step is performed in the presence of a metal oxide.

Further, the present invention relates to the production method for the organic-silica complex membrane having the sulfonic acid group, being characterized in that the condensation reaction step is performed in the presence of an acid or an alkali.

Further, the present invention relates to the production method for the organic-silica complex membrane having the sulfonic acid group, in which the condensation reaction step is performed in an atmosphere of steam, an acidic or basic gas, and/or under a reduced pressure.

Further, the present invention relates to an organic-silica complex membrane, being obtained by any one of the production methods as described above.

Further, the present invention relates to the production method for the organic-silica complex membrane having a free sulfonic acid group in the complex membrane, being characterized in that the complex membrane as described above is dipped in a solvent containing an inorganic acid and/or an organic acid.

Further, the present invention relates to the production method for the organic-silica complex membrane having the free sulfonic acid group in the complex membrane, being characterized in that the complex membrane as described above is dipped in a solvent containing at least one type selected from the group consisting of: methyl sulfate, dimethyl sulfate, an alkyl halide having from 1 to 10 carbon atoms and an alkyl halide having from 1 to 10 carbon atoms.

Further, the present invention relates to an organic-silica complex membrane, being obtained by the production method as described above.

Further, the present invention relates to an electrolyte membrane, being characterized by comprising the organic-silica complex membrane as described above.

Further, the present invention relates to an electrolyte membrane, being obtained by dipping the organic-silica complex membrane as described above in a solvent containing a lithium ion.

Further, the present invention relates to an electrochemical device, being characterized by comprising the electrolyte membrane as described above.

Further, the present invention relates to a membrane transfer device, being characterized by comprising the organic-silica complex membrane as described above.

Further, the present invention relates to a membrane reaction device, being characterized by comprising the organic-silica complex membrane as described above.

As for other advantages of these complex membranes and electrolyte membranes described in the description, since a three-dimensional cross-linked structure can be introduced into the membrane by appropriately selecting a raw material component or an additive component, swelling of the membrane is suppressed even when impregnated with water, alcohol, a non-protonic polar solvent, an auxiliary electrolyte solution or the like and, further, since a halogen element is not introduced in a skeletal structure of the membrane by a covalent bond, the complex membrane or the electrolyte membrane which can contribute to reduction of an environmental load in the production process and upon disposal after the use can be provided.

The present invention relates to a novel organic-silica complex membrane having a sulfonic acid group to be provided by a sol-gel process system in which an alkoxysilane is condensed in a self-catalytic manner by a sulfonic acid generated by a reaction between an amine and a cyclic sultone and, by controlling a raw material composition, it becomes possible to obtain the organic-silica complex membrane having any one of various features from that in a gel state to a self-standing flexible tenacious membrane. Since this organic-silica complex membrane exhibits characteristics of an electrolyte membrane, it is possible to apply the membrane to an electrochemical device. Further, since the membrane has a sulfonic acid group or an amine, it can be expected to selectively incorporate a specified chemical substance into the membrane and, by being mixed with other metallic species, the membrane can be imparted with functionality such as catalytic activity and expected to be applied to a membrane transfer device or a membrane reaction device.

### BEST MODE FOR CARRYING OUT THE INVENTION

Hereinafter, the present invention will be described in more detail.

An alkoxysilane compound having an amino group to be used in the present invention contains one or a plurality of primary, secondary or tertiary amino groups in a molecule, can derive a sulfonic acid group by being reacted with a cyclic sultone and is not particularly limited so long as it can provide ion conductivity, adsorption or permeability of a substance, reactivity, and thermal characteristics/mechanical characteristics sustainable to a service environment, sufficient for being used in an electrochemical device, a membrane transfer device or a membrane reaction device to be targeted at. Specifically, such alkoxysilane compounds as represented by the following general formulae (1) to (5) can be used:

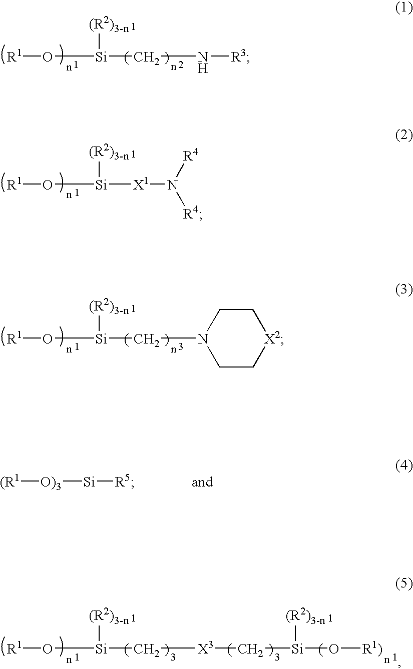

wherein R¹ represents a methyl group or an ethyl group;

R² represents a hydrogen atom, a methyl group or an ethyl group;

R³ represents a hydrogen atom, a methyl group, an ethyl group, an allyl group, a phenyl group or an organic group represented by the following general formula (6);

R⁴ represents a methyl group, an ethyl group or a hydroxyethyl group;

R⁵ represents a 3-(N-phenylamino)propyl group, a 3-(4,5-dihydroimidazolyl)propyl group or a 2-[N-(2-aminoethyl)aminomethyl phenyl]ethyl group;

X¹ represents a divalent alkylene having from 1 to 6 carbon atoms;

X² represents methylene which is a divalent organic group, oxygen or a secondary amine;

X³ represents a divalent organic group represented by —NH— or —NHCH₂CH₂NH—;

n¹ represents an integer of from 1 to 3;

n² represents an integer of from 1 to 6; and

n³ represents an integer of from 1 to 3:

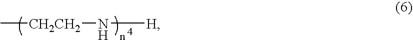

wherein n⁴ represents an integer of from 0 to 2.

The alkoxysilane compound is not particularly limited for the number of carbon atoms of an alkoxy group so long as the sol-gel process is progressed; however, in order to reduce the contraction of the membrane at the time of formation of the membrane, those having one carbon atom or 2 carbon atoms are desirable. Further, 2 types or more of such alkoxysilane compounds each having an amino group may also be used in the form of mixtures.

By appropriately selecting an epoxy compound having at least 2 epoxy groups in a molecule to be used in the present invention, it is possible to reduce contraction of the membrane while the sol-gel process is progressed, enhance a membrane forming property and control flexibility or hydrophilicity of the membrane and permeability of a substance into the membrane. The epoxy compound which can be used is not particularly limited so long as it can provide ion conductivity, adsorption or permeability of a substance, reactivity, and thermal characteristics/mechanical characteristics sustainable to a service environment, sufficient for being used in an electrochemical device, a membrane transfer device or a membrane reaction device to be targeted at. Specifically, such epoxy compounds as represented by the following general formulae (7) to (28) can be used:

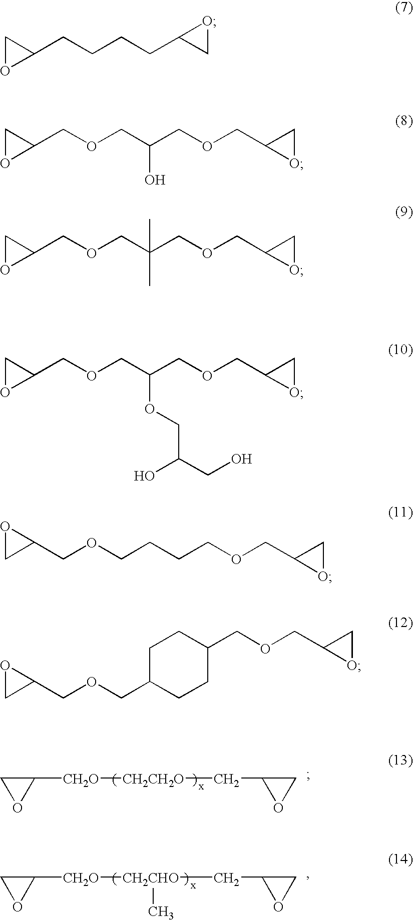

wherein x represents an integer of from 1 to 1000;

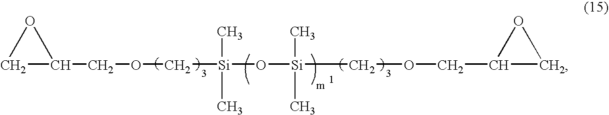

wherein m¹ represents an integer of from 1 to 100;

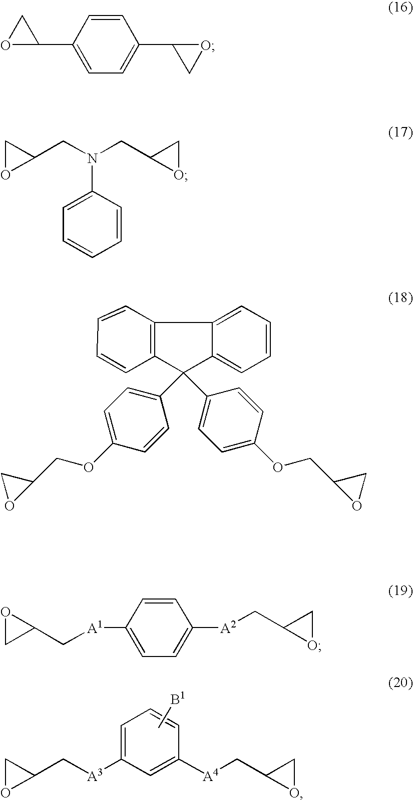

wherein A¹, A², A³ and A⁴ each independently represents a divalent linking group selected from among —O—, —C(═O)O—, —NHC(═O)O— and —OC(═O)O—; and

B¹ represents any one of substituents: —H, —CH₃ and —OCH₃;

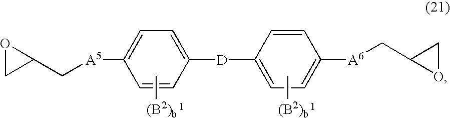

wherein A⁵ and A⁶ each independently represents a divalent linking group selected from among —O—, —C(═O)O—, —NHC(═O)O— and —OC(═O)O—;

B² represents any one of substituents: —H, —CH₃ and —OCH₃;

b¹ represents an integer of from 0 to 4;

D represents a single bond or any one of divalent linking groups: —O—, —C(═O)—, —C(═O)O—, —NHC(═O)—, —NH—, —N═N—, —CH═N—, —CH═CH—, —C(CN)═N—, —C≡C—, —CH₂—, —CH₂CH₂—, —CH₂CH₂CH₂—, —C(CH₃)₂— and the general formulae: —O—(CH₂)ₘ—O— and —O—(CH₂CH₂O)ₙ—,

wherein m represents an integer of from 2 to 12; and

n represents an integer of from 1 to 5;

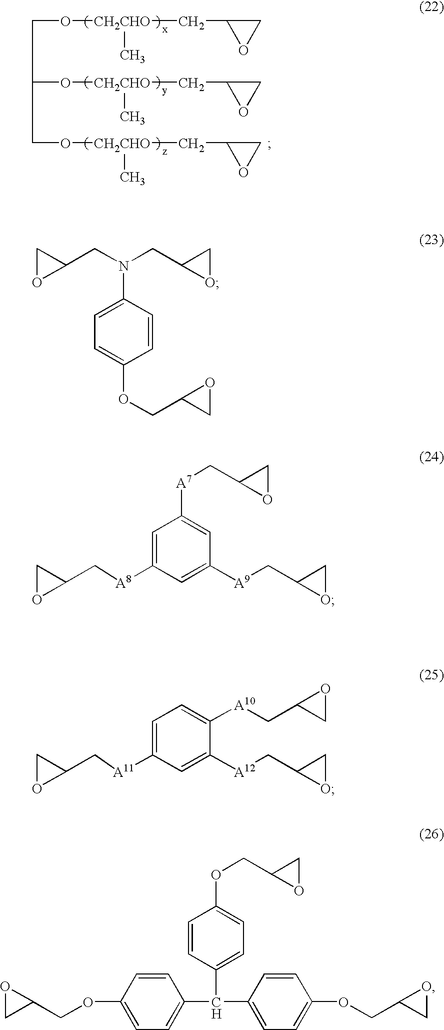

wherein x, y and z each independently represents an integer of from 1 to 20;

A⁷, A⁸ and A⁹ each independently represents a divalent linking group selected from among —O—, —C(═O)O—, —NHC(═O)O—, and —OC(═O)O—; and

A¹⁰, A¹¹ and A¹² each independently represents a divalent linking group selected from among —O—, —C(═O)O—, —NHC(═O)O— and —OC(═O)O—;

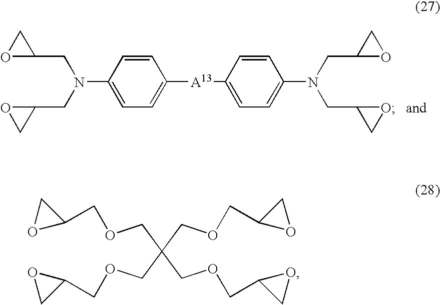

wherein A¹³ represents methylene or a linking group represented by any one of the following general formulae (29) and (30):

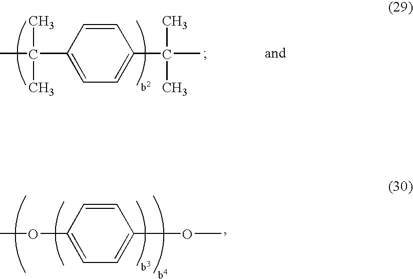

wherein b² represents an integer of from 0 to 4;

b³ represents an integer of from 1 to 3; and

b⁴ represents an integer of from 0 to 2.

Among these compounds, the epoxy compounds represented by the general formulae (7) to (15) are illustrated as components to be favorably used for providing, according to the present invention, a soft flexible organic-silica complex membrane. Further, the epoxy compounds represented by the general formulae (16) to (21) are illustrated as components to be favorably used for providing, according to the present invention, the organic-silica complex membrane excellent in thermal resistance. Still further, the epoxy compounds represented by the general formulae (22) to (28) are illustrated as components to be favorably used for providing, according to the present invention, the organic-silica complex membrane excellent in mechanical strength.

In order to control ion conductivity, thermal resistance, mechanical characteristics and productivity of the organic-silica complex membrane, 2 types or more of multifunctional epoxy compounds represented by, for example, the general formulae (7) to (28) may simultaneously be used.

The organic-silica complex membrane according to the present invention can be obtained by using the multifunctional epoxy compounds described in, for example, JP-A-No. 61-247720, 61-246219 and 63-10613 as the multivalent epoxy compounds either each individually or concurrently with such epoxy compounds as represented by the general formulae (7) to (28).

The alkoxysilane compound having an epoxy group to be used in the present invention is not particularly limited so long as it can provide ion conductivity, adsorption or permeability of a substance, reactivity, and thermal characteristics/mechanical characteristics sustainable to a service environment, sufficient for being used in an electrochemical device, a membrane transfer device or a membrane reaction device to be targeted at. Specifically, such epoxy compounds as represented by the general formula (31) or (32) can favorably be used in the present invention. Further, the epoxy compounds represented by the general formulae (31) and (32) may be used each individually or in combinations thereof.

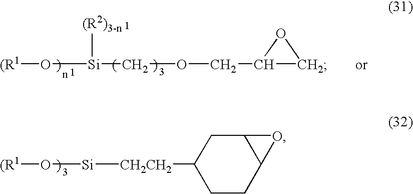

wherein R¹ and R² each independently represents a methyl group or an ethyl group; and

n¹ represents an integer of from 1 to 3.

An amine compound having at least 2 amine valences (number of hydrogen atoms originated in an amino group contained in one molecule) to be used in the present invention is not particularly limited so long as it reacts with an epoxy group and acyclic sultone to derive an organic-silica complex membrane and the thus derived organic-silica complex membrane can provide ion conductivity, adsorption or permeability of a substance, reactivity, and thermal characteristics/mechanical characteristics sustainable to a service environment, sufficient for being Used in an electrochemical device, a membrane transfer device or a membrane reaction device to be targeted at. Specifically, such amine compounds as represented by the following general formula (33) to (51) can be used in the present invention:

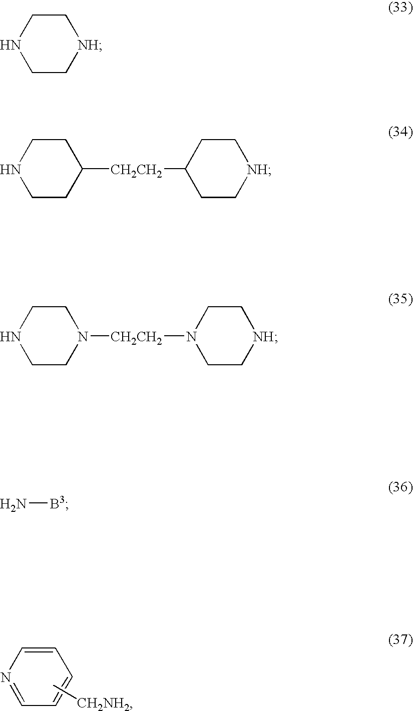

wherein B³ represents a hydrocarbon group having from 2 to 18 carbon atoms or a group having at least one ether bond in a hydrocarbon chain;

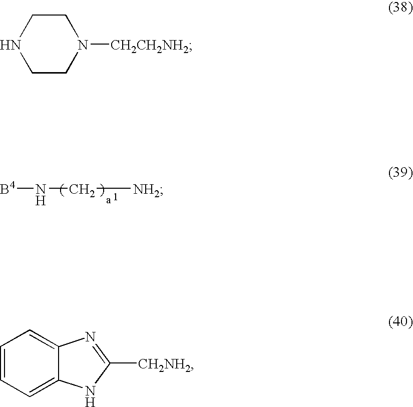

wherein a¹ represents an integer of from 2 to 18;

B⁴ represents a hydrocarbon group having from 1 to 18 carbon atoms or a group having at least one ether bond in a hydrocarbon chain;

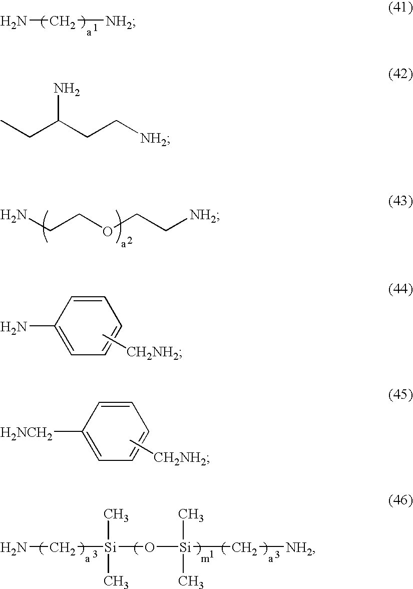

wherein a¹ represents an integer of from 2 to 18;

a² represents an integer of from 1 to 10000;

m¹ represents an integer of from 1 to 100; and

a³ represents an integer of from 3 to 18;

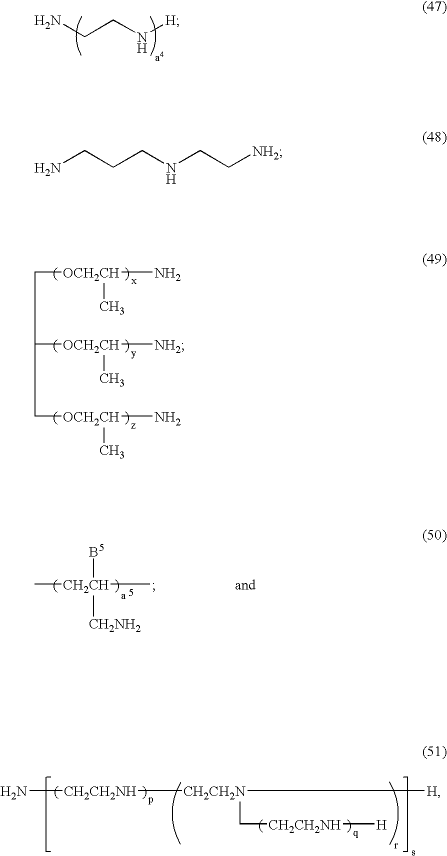

wherein a⁴ represents an integer of from 2 to 100;

x, y and z each independently represent an integer of from 1 to 20;

a⁵ represents an integer of from 2 to 1000;

B⁵ represents hydrogen or a methyl group; and

p, q, r and s each independently represent an integer of from 1 to 20.

Further, in order to control ion conductivity, thermal resistance, mechanical characteristics and productivity of the electrolyte membrance, 2 types or more of amine compounds represented by, for example, the general formulae (33) to (51) may simultaneously be used.

A cyclic sultone (cyclic sulfonic acid ester) to be used in the present invention is not particularly limited so long as it is introduced in the complex membrane by reacting with an amine and can provide ion conductivity, adsorption or permeability of a substance, reactivity, and thermal characteristics/mechanical characteristics sustainable to a service environment, sufficient for being used in an electrochemical device, a membrane transfer device or a membrane reaction device to be targeted at. Specifically, such cyclic sultones, which are easily obtainable from a practical standpoint, as represented by the general formula (52) and (53) can be used in the present invention. Further, the cyclic sultones represented by the following general formulae (52) and (53) may be used each individually or in combinations thereof:

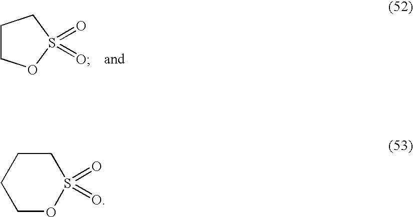

In a reaction between an amine compound and a cyclic sultone, or an epoxy compound and an amine compound, and a condensation reaction (sol-gel process) subsequent thereto, an organic solvent can ordinarily be appropriately used in order to progress these reactions in a uniform manner. On this occasion, the organic solvent is not particularly limited unless it reacts with the epoxy compound, remarkably reduces nucleophilicity of an amine, reacts with the cyclic sultone or gives a detrimental effect to a configuration of a formed membrane and, for example, n-hexane, cyclohexane, n-heptane, n-octane, ethyl Cellosolve, butyl Cellosolve, benzene, toluene, xylene, anisol, methanol, ethanol, isopropanol, butanol, ethylene glycol, diethyl ether, tetrahydrofuran, 1,4-dioxane, ethyl acetate, butyl acetate, acetone, methyl ethyl ketone, N,N-dimethyl formamide, N,N-dimethylacetamide, N-methyl-2-pyrrolidinone and dimethyl sulfoxide can be used. Further, optionally, these solvents can be used in mixtures of 2 types or more and, further, after being supplied with water. From the purpose of progressing the reaction, an organic solvent containing a halogen element such as chloroform, dichloromethane, 1,2-dichloroethane, 1,1,2,2-tetrachloroethane, chlorobenzene, or dichlorobenzene can be used. However, from the standpoint of “less environmental load” which is one problem according to the present invention, the organic solvent containing the halogen element is not desirable as an embodiment according to the present invention. Nevertheless, so long as it is judged that leakage thereof into the environment can be avoided by a relatively small input of energy, it is not particularly limited.

Hereinafter, a production method of an organic-silica complex membrane according to the present invention is described.

When a cyclic sultone is loaded in a reaction system, it can derive a sulfonic acid group by reacting with an amino group. Further, the sulfonic acid group acts as a catalyst, to thereby progress a condensation reaction (sol-gel process). A speed of the condensation reaction (sol-gel process) largely varies depending on a raw material compound, a solvent, a concentration of a substrate, temperature and the like; however, a reaction condition is set such that gelation becomes conspicuous approximately in a few minutes to a few hours and, then, while a reaction solution is still flowable, the membrane is formed by a solvent cast method, a spin coat method, a transfer method, a printing method or the like and, thereafter, a separated component generated by the condensation, solvent or the like is removed by heating, reducing a pressure or the like, to thereby obtain an organic-silica complex membrane having a sulfonic acid group.

For example, when an alkoxysilane compound having an amino group is allowed to react with a cyclic sultone, the cyclic sultone of from 10% to 100% by equivalent is added per amine valence and, then, stirred for from a few minutes to a few hours at from 0 to 150° C., preferably from 20 to 120° C., to thereby introduce a sulfonic acid group into the alkoxysilane compound. Subsequently, before the resultant reaction product is gelated or solidified, or yields a deposited article, a membrane is formed and, then, an alkoxysilane is subjected to a condensation reaction (sol-gel process), to thereby obtain the organic-silica complex membrane according to the present invention. A concentration of the reaction solution to be used on this occasion is not particularly limited so long as the solution can uniformly be stirred and ordinarily is, based on the substrate, approximately from 0.1 to 10 mol/L. Further, unless causing a problem for forming a membrane, the solvent may not be used.

Still further, when a secondary or tertiary amine derivative is obtained by allowing an alkoxysilane compound having an amino group to react with a compound having at least 2 epoxy groups in a molecule, when a secondary or tertiary amine derivative is obtained by allowing an alkoxysilane compound having an epoxy group to react with an amine compound having at least 2 amine valences, or when a secondary or tertiary amine derivative is obtained by allowing an alkoxysilane compound having an amino group to react with an alkoxysilane compound having an epoxy group, an epoxy compound of from 10 to 90% by equivalent per amine valence is added and, then, these compounds are uniformly mixed with each other and dissolved by using a solvent and, thereafter, stirred for from a few minutes to scores of hours at from 0 to 150° C., preferably from 20 to 120° C., to thereby subject the epoxy compound to a curing reaction. Subsequently, before the solution is gelated or solidified, or yields a deposited article, the cyclic sultone of from 10 to 100% by equivalent is added against remaining amine valence. Thereafter, the resultant solution is stirred for from a few minutes to a few hours at from 20 to 150° C. and, then, before the solution is gelated or solidified, or yields a deposited article, a membrane is formed and an alkoxysilane is subjected to a condensation reaction (sol-gel process), to thereby obtain the organic-silica complex membrane according to the present invention. On this occasion, at least 2 types of amine compounds and/or at least 2 types of epoxy compounds can be used and these compounds can be mixed either simultaneously or among same types of components. A concentration of the reaction solvent to be used on this occasion is not particularly limited so long as the solution can uniformly be stirred, and ordinarily is, based on the substrate, approximately from 0.1 to 10 mol/L. Further, unless causing any problem for forming a membrane, the solvent may not be used.

Further, according to the present invention, a step of introducing a sulfonic acid group by using a cyclic sultone and a condensation reaction step to be performed thereafter are not necessarily conspicuously separated from each other and a method in which the step of introducing the sulfonic acid group and the condensation reaction step are simultaneously progressed is included in production methods according to the present invention.

In order to improve the mechanical strength, the thermal resistance or the like of the organic-silica complex membrane having a sulfonic acid group according to the present invention, or in order to impart the organic-silica complex membrane with a function of a catalytic performance or the like, when the condensation reaction is performed by a so-called sol-gel copolycondensation, a metal alkoxide may further be used. The metal alkoxide to be used is not particularly limited so long as it does not react by itself with any one of the alkoxysilane compounds each having the amino group or the epoxy group as represented by the general formulae (1) to (5), (31) and (32) and is capable of performing the sol-gel copolycondensation in the presence of a sulfonic acid group generated by the reaction between the cyclic sultone and the amine and, as a result, can provide ion conductivity, adsorption or permeability of a substance, reactivity, and thermal characteristics/mechanical characteristics sustainable to a service environment, sufficient for being used in an electrochemical device, a membrane transfer device or a membrane reaction device to be targeted at. Specifically, such metal alkoxides as represented by the following general formulae (54) to (61) can be used in the present invention:

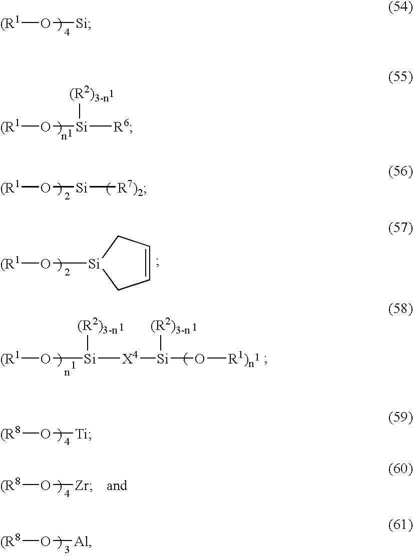

wherein R¹ and R² each independently represent a methyl group or an ethyl group;

R⁶ represents an alkyl group or alkenyl group having from 1 to 18 carbon atoms, a 2-cyanoethyl group, a 3-cyanopropyl group, a cyclohexyl group, a 2-(3-cyclohexenyl)ethyl group, a 3-cyclopentadienyl propyl group, a phenyl group, a toluyl group or a monovalent organic group having a quaternary ammonium group represented by the following general formula (62);

R⁷ represents a cycloalkyl group or cycloalkenyl group having 5 or 6 carbon atoms;

R⁸ represents an alkyl group or alkenyl group having from 1 to 4 carbon atoms;

X⁴ represents a single bond, oxygen, an alkylene group having from 1 to 9 carbon atoms, a vinylene group or a divalent organic group represented by the following general formula (63) to (65); and

n¹ represents an integer of from 1 to 3:

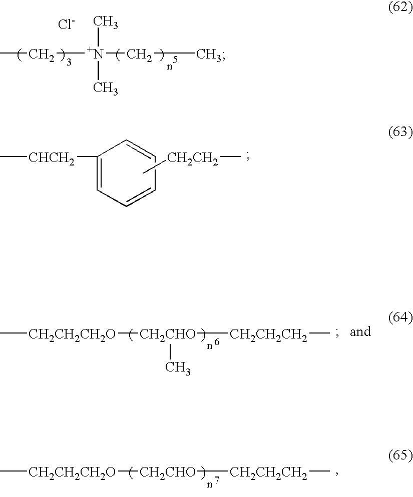

wherein n⁵ represents an integer of from 0 to 13;

n⁶ represents an integer of from 1 to 10; and

n⁷ represents an integer of from 0 to 20.

On this occasion, the compounds represented by the general formulae (54) to (58) are metal alkoxides each having silicon as a metal element and, since alkoxysilane compounds having various types of organic groups and functional groups are available in the market, it is convenient to control a function or a feature of the membrane. It goes without saying that a corresponding alkoxysilane compound may be synthesized by using a known technique such as a hydrosilylation reaction between an alkene derivative and an alkoxysilane compound having a hydrosilyl group. As for metal alkoxides containing other metals than silicon to be used in the present invention, an alkoxide having from 1 to 4 carbon atoms containing, for example, boron, aluminum, phosphorous, titanium, vanadium, nickel, zinc, germanium, yttrium, zirconium, niobium, tin, antimony, tantalum or tungsten can be used; for example, those represented by the general formulae (59) to (61) can be illustrated.

Further, these metal alkoxides may be used each individually or in combination of 2 types or more thereof.

An amount of the metal alkoxide to be added on this occasion is not particularly limited so long as desired mechanical strength or thermal resistance, catalytic performance or the like can be obtained; however, it is ordinarily added in the range, based on an organic-silica complex membrane to be finally obtained, of from 1 to 50% by weight.

In order to improve the mechanical strength or thermal resistance of the organic-silica complex membrane having a sulfonic acid group according to the present invention, or in order to impart the organic-silica-complex membrane with a function such as the catalytic performance, the condensation reaction (sol-gel process) of the alkoxysilane derivative may be performed in the presence of a metal oxide. Accordingly, the metal oxide is fixed in a matrix. The metal oxide to be used is not particularly limited so long as the organic silica complex membrane which is prepared by using it can provide ion conductivity, adsorption or permeability of a substance, reactivity, and thermal characteristics/mechanical characteristics sustainable to a service environment, sufficient for being used in an electrochemical device, a membrane transfer device or a membrane reaction device to be targeted at, and an oxide of, for example, aluminum, calcium, titanium, vanadium, zinc, germanium, strontium, yttrium, zirconium, niobium, tin, antimony, barium, tantalum or tungsten can be used.

Further, these metal oxides may be used each individually or in combination of 2 types or more thereof.

On this occasion, an amount of the metal oxide to be added is not particularly limited so long as desired mechanical strength or thermal resistance, catalytic performance or the like can be obtained and the metal oxide is ordinarily added in the range, based on the organic-silica complex membrane to be finally obtained, of from 1 to 50% by weight.

Further, in the production method of the organic-silica complex membrane according to the present invention, a progress of the condensation reaction can be promoted by allowing an acid or an alkali to be present in the condensation reaction step. The acid or alkali to be used on this occasion is not particularly limited so long as it promotes the progress of the condensation reaction and, for example, hydrochloric acid, bromic acid, hydrogen iodide, sulfuric acid, nitric acid, phosphoric acid, trifluoroacetic acid, lithium hydroxide, sodium hydroxide, potassium hydroxide, sodium carbonate, potassium carbonate, calcium hydroxide or cesium hydroxide can be mentioned. An amount of the acid or alkali to be added is not particularly limited so long as it promotes the progress of the condensation reaction and it is ordinarily added in the range, based on the cyclic sultone to be added to the reaction solution, of from 1 to 120% by mol.

Further, in the production method of the organic-silica complex membrane according to the present invention, by performing the condensation reaction in the atmosphere of steam, an acidic gas or basic gas, and/or under a reduced pressure, the progress of the condensation reaction can be promoted. The acidic or basic gas to be used on this occasion is not particularly limited so long as it promotes the progress of the condensation reaction and, for example, hydrogen chloride, hydrogen bromide, ammonia, trimethyl amine, ethyl amine, diethyl amine can be mentioned. A concentration of the steam, acidic gas or basic gas to be used on this occasion is not particularly limited so long as it promotes the progress of the condensation reaction and it is ordinarily controlled to have a partial pressure of from 0.1 MPa to 100 Pa in a reaction atmosphere. Further, an extent of the reduced pressure can be in the range, for example, of from 0.1 MPa to 0.1 Pa.

In the organic silica complex membrane having a sulfonic acid group to be obtained according to the present invention, the sulfonic acid group and an amine residue are strongly interacted with each other and, then, there are cases in which sufficient electrolyte characteristics can not be obtained depending on applications. This is due to an influence of a betaine configuration in which a proton is coordinated to the amine residue or in a case in which the cyclic sultone reacts with a tertiary amine. Then, by treating the organic-silica complex membrane by a solution containing sulfuric acid or the like, a sulfonate ion can be converted into a free sulfonic acid, to thereby enhance the electrolyte characteristics, molecule-recognizing performance, catalytic action and the like. A rate of such conversion of this sulfonate ion to the free sulfonic acid is not particularly limited so long as sufficient device characteristics can be expressed in a specified application. Such conversion treating agent is not particularly limited so long as it generates the free sulfonic acid in the membrane, and a compound, for example, an inorganic acid such as sulfuric acid, nitric acid, hydrochloric acid, hydrogen bromide, hydrogen iodide or phosphoric acid, an organic acid such as benzene sulfonic acid, toluene sulfonic acid, fluoroacetic acid, chloroacetic acid, bromoacetic acid, trifluoroacetic acid or trichloroacetic acid, methyl sulfate, dimethyl sulfate, an alkyl halide having from 1 to 10 carbon atoms or an allyl halide having from 1 to 10 carbon atoms can be used; from the standpoint of easy handling and low cost, sulfuric acid or hydrochloric acid is favorable. The solvent to be used on this occasion is not particularly limited so long as the conversion treating agent acts without impairing the membrane, and water, alcohol having from 1 to 4 carbon atoms, acetic acid, acetone, tetrahydrofuran, 1,4-dioxane, N,N-dimethyl formamide, N,N-dimethyl acetamide, N-methyl-2-pyrrolidinone, dimethylsulfoxide and the like can be used either each individually or in mixtures of 2 types or more thereof. The conversion treatment is not particularly limited so long as the membrane comes in contact with the solution in which the conversion treating agent is mixed in the aforementioned solvent, and a treating temperature may appropriately be determined within a range of from 0 to 150° C. in accordance with types of solvents or taking an influence to the membrane into consideration.

The organic-silica complex membrane having the sulfonic acid group to be obtained according to the present invention can be used as an electrolyte membrane as it is. Further, by doping a lithium ion thereinto, the membrane can be used as the electrolyte membrane for a lithium ion secondary battery. In order to realize a practical transference number of the lithium ion, a composition may be controlled such that a feature of the organic-silica complex membrane becomes a soft gelled electrolyte by using a compound having a multiple of ether bonds as an epoxy compound, amine compound or alkoxysilane compound to be used at the time of synthesizing the organic-silica complex membrane. As for a method for doping the lithium ion, for example, a known method as described in “high density lithium secondary battery (Technosystems, 1998)” may be used. For example, by dipping the organic silica complex membrane in a solvent containing the lithium ion, the lithium ion can be doped thereinto, to thereby obtain the electrolyte membrane. An amount of the lithium ion to be doped is appropriately determined such that a desired transference number is obtained, and it is ordinarily in the range, based on the organic-silica complex membrane, of from 0.1 to 10% by weight.

In a case in which elusion of impurities or the like from the membrane gives a detrimental influence to a performance of the electric device, the organic-silica complex membrane is rinsed and, then, provided for such application. It is possible to make use of the conversion treatment for generating the aforementioned free sulfonic acid as such rinsing treatment as it is, or it is also possible to dip the membrane in a solvent such as water, alcohol having from 1 to 4 carbon atoms, acetone, tetrahydrofuran, 1,4-dioxane, N,N-dimethyl formamide or N,N-dimethyl acetamide such that the impurities or the like are eluted into the solvent. Then, it is desirable that the resultant organic-silica complex membrane is further dipped in distilled water for from a few hours to a few days to complete the rinsing.

A thermal decomposition temperature of the organic-silica complex membrane to be obtained according to the present invention is ordinarily from 200 to 350° C. and preferably from 230 to 320° C. Further, the term “thermal decomposition temperature” as used herein refers to a temperature to cause weight reduction of 5% when the temperature is raised at a rate of 10° C./min. in the air.

By using the electrolyte membrane according to the present invention, various types of electrochemical devices can be produced. Examples of the electrochemical devices according to the present invention include an electric demineralization-type deionizer, a secondary battery, a fuel cell, a humidity sensor, an ion sensor, a gas sensor, an electrochromic device and a desiccant.

Further, by using the organic-silica complex membrane according to the present invention, various types of membrane transfer devices or membrane reaction devices can be produced. Examples of the membrane transfer devices according to the present invention include a liquid separation membrane and a gas separation membrane. Examples of the membrane reaction device according to the present invention include a membrane reaction apparatus and a membrane catalyst.

### EXAMPLES

Hereinafter, the present invention will be described in more detail by illustrating embodiments but is not limited thereto.

### Example 1

1.7 g (5.0 mmol) of bis(trimethoxysilyl propyl)amine was weighed and put in a short-neck flask and, then, supplied with 5.0 ml of methanol in an atmosphere of argon. The resultant solution was supplied with 0.44 ml (5.0 mmol) of 1,3-propane sultone at room temperature and, then, stirred for 2 hours. Thereafter, the resultant reaction solution was extended in a flowing manner on a Teflon sheet having sizes of 5 cm×5 cm horizontally placed in a thermostat and, then, subjected to a thermal treatment for 12 hours at 60° C., to thereby obtain a tenacious membrane. When the thus obtained membrane was subjected to an IR measurement, since absorption peaks based on a sulfonic acid were observed at 1146 cm⁻¹ and 1041 cm⁻¹ and an absorption peak based on a siloxane bond was observed at around 1100 cm⁻¹ (as a shoulder peak of the absorption peak of 1146 cm⁻¹ based on the sulfonic acid), it was confirmed that a structure in which a sol-gel process was progressed and a sulfonic acid group was introduced was formed. A thermal decomposition temperature of the product was 309° C. A conceivable structural formula of the product is as follows:

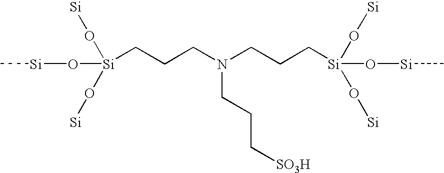

### Example 2

0.85 g (2.5 mmol) of 2,2-bis(4-glycidyl oxyphenyl)propane was weighed and put in a short-neck flask and supplied with 7.5 ml of N,N-dimethyl formamide (hereinafter, referred to also as “DMF”) in an atmosphere of argon. The resultant solution was supplied with 0.87 ml (5.0 mmol) of 3-aminopropyl trimethoxysilane and, then, heated to 60° C. in an oil bath and, thereafter, stirred for 2 hours and, subsequently, further stirred for 2 hours at 80° C. The resultant reaction solution was supplied with 0.44 ml (5.0 mmol) of 1,3-propane sultone and, then, stirred for 30 minutes. Thereafter, 4.0 ml of the resultant reaction solution was extended in a flowing manner on a Teflon sheet having sizes of 5 cm×5 cm horizontally placed in a thermostat and, then, subjected to a thermal treatment for 12 hours at 60° C., to thereby obtain a soft membrane. When the thus obtained membrane was subjected to an IR measurement, since absorption peaks at 3057 cm⁻¹ and 829 cm⁻¹ based on an epoxy ring and absorption peaks at around 3300 cm⁻¹ and 1574 cm⁻¹ based on an amino group were disappeared, and absorption peaks at around 1150 cm⁻¹ (as a shoulder peak of an absorption peak of 1185 cm⁻¹ based on an ether bond) and 1039 cm⁻¹ based on sulfonic acid and, further, an absorption peak at around 1100 cm⁻¹ (as a shoulder peak of the absorption peak of 1185 cm⁻¹ based on the ether bond) based on a siloxane bond were observed, it was confirmed that a structure in which a sol-gel process was progressed and a sulfonic acid group was introduced was formed. A thermal decomposition temperature of the product was 296° C. A conceivable structural formula of the product is as follows:

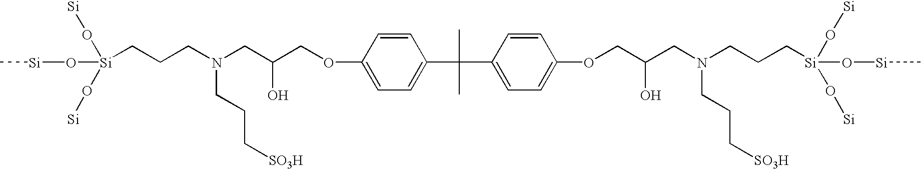

### Example 3

0.90 g (2.6 mmol) of 2,2-bis(4-glycidyl oxyphenyl)propane was weighed and put in a short-neck flask and supplied with 7.9 ml of ethanol in an atmosphere of argon. The resultant solution was supplied with 0.92 ml (5.3 mmol) of 3-aminopropyl trimethoxysilane and, then, heated to 80° C. in an oil bath and, thereafter, stirred for 2 hours. The resultant reaction solution was supplied with 0.46 ml (5.3 mmol) of 1,3-propane sultone and, then, stirred for 30 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft transparent membrane. Thickness of the membrane was 145 μm. When the thus-obtained membrane was subjected to an IR measurement, since absorption peaks at around 1150 cm⁻¹ (as a shoulder peak of the absorption peak of 1185 cm⁻¹ based on an ether bond) and 1037 cm⁻¹ based on sulfonic acid and, further, an absorption peak at around 1100 cm⁻¹ (as a shoulder peak of the absorption peak of 1185 cm⁻¹ based on the ether bond) based on a siloxane bond were observed, it was confirmed that a structure in which a sol-gel process was progressed and a sulfonic acid group was introduced was formed. A thermal decomposition temperature of the product was 292° C. A conceivable structural formula of the product is as follows:

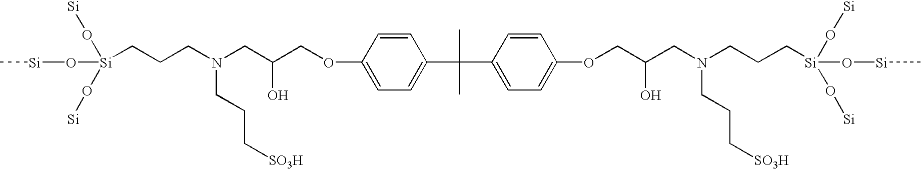

### Example 4

0.92 g (2.7 mmol) of 2,2-bis(4-glycidyl oxyphenyl)propane was weighed and put in a short-neck flask and supplied with 8.1 ml of DMF in an atmosphere of argon. The resultant solution was supplied with 1.6 ml (5.4 mmol) of (aminoethyl aminomethyl) phenethyl trimethoxysilane and, then, heated to 80° C. in an oil bath and, thereafter, stirred for 2 hours. The resultant reaction solution was supplied with 0.48 ml (5.4 mmol) of 1,3-propane sultone and, then, stirred for 30 minutes. Thereafter, the resultant reaction solution was extended in a flowing manner on a Teflon sheet having sizes of 5 cm×5 cm horizontally placed in a thermostat and, then, subjected to a thermal treatment for 12 hours at 60° C., to thereby obtain a soft membrane. When the thus-obtained membrane was subjected to an IR measurement, since absorption peaks at around 1150 cm⁻¹ (as a shoulder peak of an absorption peak of 1186 cm⁻¹ based on an ether bond) and 1038 cm⁻¹ based on sulfonic acid and, further, an absorption peak at around 1100 cm⁻¹ (as a shoulder peak of the absorption peak of 1185 cm⁻¹ based on the ether bond) based on a siloxane bond were observed, it was confirmed that a structure in which a sol-gel process was progressed and a sulfonic acid group was introduced was formed. A thermal decomposition temperature of the product was 273° C. A conceivable structural formula of the product is as follows:

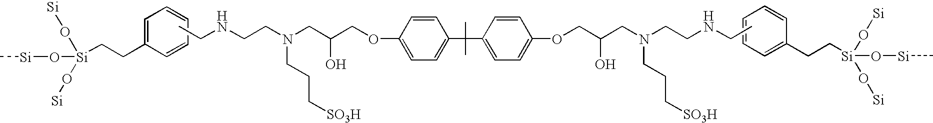

### Example 5

1.2 g (2.5 mmol) of 9,9-bis(4-glycidyl oxyphenyl)fluorine was weighed and put in a short-neck flask and supplied with 7.5 ml of dry THF in an atmosphere of argon. The resultant solution was supplied with 0.87 ml (5.0 mmol) of 3-aminopropyl trimethoxysilane and, then, heated to 70° C. in an oil bath and, thereafter, stirred for 19 hours and, subsequently, cooled to room temperature and, then, further cooled with ice. The resultant reaction solution was supplied with 0.44 ml (5.0 mmol) of 1,3-propane sultone and, then, stirred for 15 minutes. Thereafter, the resultant reaction solution was extended in a flowing manner on a polypropylene container having sizes of 5 cm×7.5 cm placed in a thermostat and, then, subjected to a thermal treatment for 12 hours at 60° C., to thereby obtain a tenacious membrane. Thickness of the membrane was 131 μm. When the thus-obtained membrane was subjected to an IR measurement, since absorption peaks at around 1150 cm⁻¹ (as a shoulder peak of the absorption peak of 1180 cm⁻¹ based on an ether bond) and 1039 cm⁻¹ based on sulfonic acid and, further, an absorption peak at around 1110 cm⁻¹ (as a shoulder peak of the absorption peak of 1185 cm⁻¹ based on the ether bond) based on a siloxane bond were observed, it was confirmed that a structure in which a sol-gel process was progressed and a sulfonic acid group was introduced was formed. A thermal decomposition temperature of the product was 303° C. A conceivable structural formula of the product is as follows:

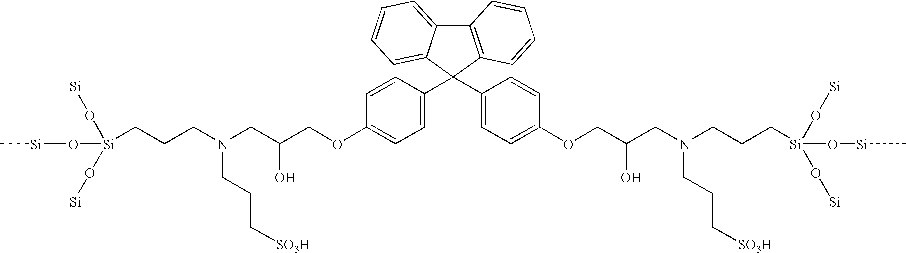

### Example 6

0.37 ml (2.5 mmol) of triethylene tetramine was weighed and put in a short-neck flask and supplied with 5.0 ml of 2-propanol in an atmosphere of argon. The resultant solution was supplied with 1.1 ml (5.0 mmol) of 3-glycidyloxypropyl trimethoxysilane and, then, heated to 80° C. in an oil bath and, thereafter, stirred for 24 hours. The resultant reaction solution was supplied with 0.88 ml (10 mmol) of 1,3-propane sultone and, then, stirred for 15 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. Thickness of the membrane was 180 μm. When the thus-obtained membrane was subjected to an IR measurement, since absorption peaks at 1168 cm⁻³ and 1040 cm⁻¹ based on sulfonic acid and, further, an absorption peak at around 1100 cm⁻¹ (as a shoulder peak of an absorption peak of 1108 cm⁻¹ based on an ether bond) based on a siloxane bond were observed, it was confirmed that a structure in which a sol-gel process was progressed and a sulfonic acid group was introduced was formed. A thermal decomposition temperature of the product was 281° C. A conceivable structural formula of the product is as follows:

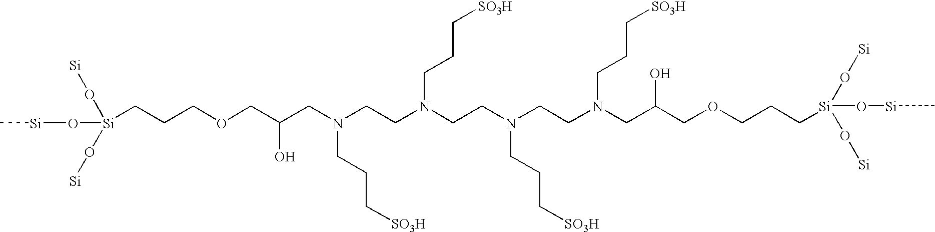

### Example 7

0.39 ml (1.6 mmol) of poly(propylene glycol)bis(2-aminopropyl)ether was weighed and put in a short-neck flask and, then, supplied with 4.8 ml of 2-propanol in an atmosphere of argon. The resultant solution was supplied with 0.70 ml (3.2 mmol) of 3-glycidyloxypropyl trimethoxysilane and, then, heated to 80° C. in an oil bath and, thereafter, stirred for 24 hours. The resultant reaction solution was supplied with 0.28 ml (3.2 mmol) of 1,3-propane sultone and, then, stirred for 15 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. Thickness of the membrane was 81 μm. When the thus-obtained membrane was subjected to an IR measurement, since absorption peaks at 1164 cm⁻¹ and 1041 cm⁻¹ based on sulfonic acid and, further, an absorption peak at 1110 cm⁻¹ based on a siloxane bond were observed, it was confirmed that a structure in which a sol-gel process was progressed and a sulfonic acid group was introduced was formed. A thermal decomposition temperature of the product was 270° C. A conceivable structural formula of the product is as follows:

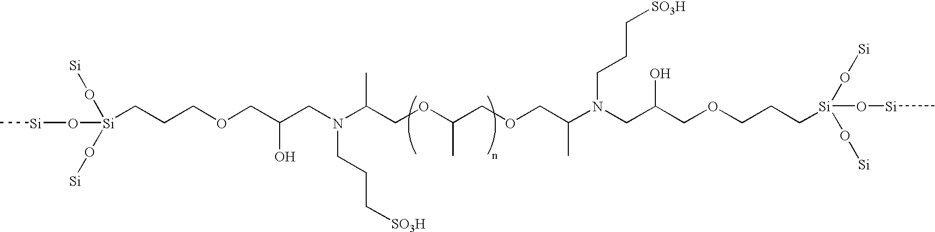

### Example 8

0.37 ml (2.5 mmol) of triethylene tetramine and 0.39 ml (1.6 mmol) of poly(propylene glycol)bis(2-aminopropyl)ether were weighed and put in a short-neck flask and, then, supplied with 17 ml of 2-propanol in an atmosphere of argon. The resultant solution was supplied with 1.8 ml (8.2 mmol) of 3-glycidyloxypropyl trimethoxysilane and, then, heated to 80° C. in an oil bath and, thereafter, stirred for 24 hours. The resultant reaction solution was supplied with 1.2 ml (13 mmol) of 1,3-propane sultone and, then, stirred for 15 minutes. Thereafter, 7.5 ml of the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. When the thus-obtained membrane was subjected to an IR measurement, since absorption peaks at 1172 cm⁻¹ and 1042 cm⁻¹ based on sulfonic acid and, further, an absorption peak at 1094 cm⁻¹ based on a siloxane bond were observed, it was confirmed that a structure in which a sol-gel process was progressed and a sulfonic acid group was introduced was formed. A thermal decomposition temperature of the product was 277° C. A conceivable structural formula of the product is as follows:

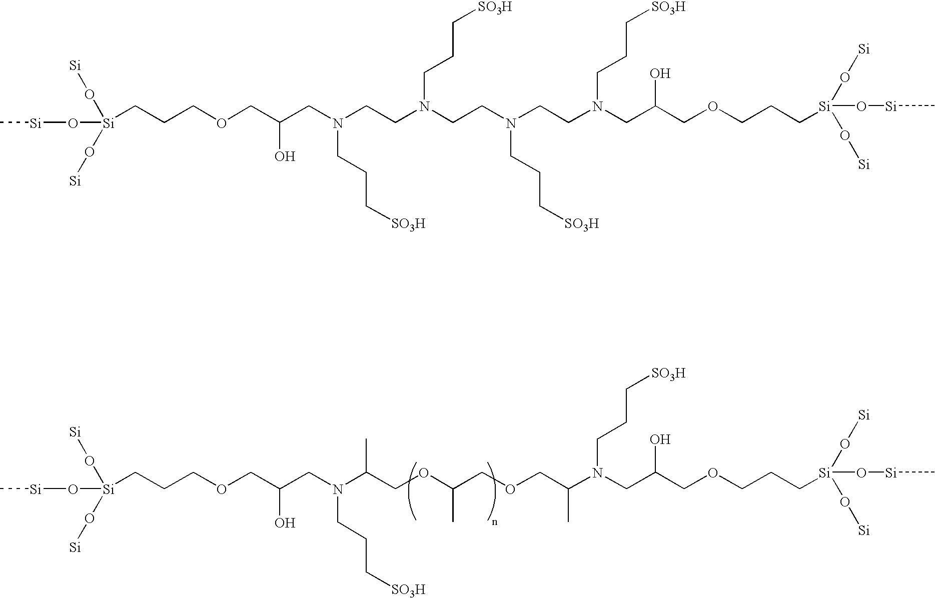

### Example 9

0.60 ml (1.0 mmol) of polyethylene imine was weighed and put in a short-neck flask and, then, supplied with 15 ml of 2-propanol in an atmosphere of argon. The resultant solution was supplied with 1.5 ml (6.7 mmol) of 3-glycidyloxypropyl trimethoxysilane and, then, heated to 80° C. in an oil bath and, thereafter, stirred for 28 hours. The resultant reaction solution was supplied with 0.61 ml (6.7 mmol) of 1,3-propane sultone and, then, stirred for 30 minutes and, subsequently, supplied with 0.38 ml (21 mmol) of distilled water and, then, stirred for 15 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. Thickness of the membrane was 126 μm. When the thus-obtained membrane was subjected to an IR measurement, since absorption peaks at 1168 cm⁻¹ and 1040 cm⁻¹ based on sulfonic acid and, further, an absorption peak at 1096 cm⁻¹ based on a siloxane bond were observed, it was confirmed that a structure in which a sol-gel process was progressed and a sulfonic acid group was introduced was formed. A thermal decomposition temperature of the product was 277° C. A conceivable structural formula of the product is as follows:

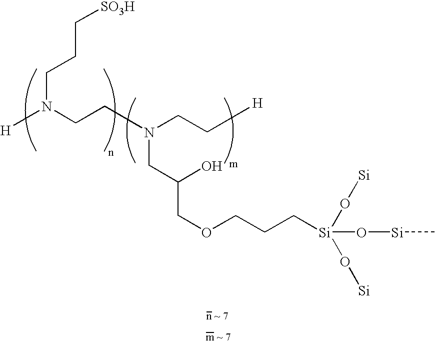

### Example 10

0.37 ml (2.5 mmol) of triethylene tetramine was weighed and, then, supplied with 7.5 ml of 2-propanol in an atmosphere of argon. The resultant solution was supplied with 1.1 ml (5.0 mmol) of 3-glycidyloxypropyl dimethoxymethylsilane and, then, heated to 80° C. in an oil bath and, thereafter, stirred for 27 hours. The resultant reaction solution was supplied with 0.88 ml (10 mmol) of 1,3-propane sultone and 0.18 ml (10 mmol) of distilled water and, then, further stirred for one hour. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. When the thus-obtained membrane was subjected to an IR measurement, since absorption peaks at 1193 cm⁻¹ and 1042 cm⁻¹ based on sulfonic acid and, further, an absorption peak at 1088 cm⁻¹ based on a siloxane bond were observed, it was confirmed that a structure in which a sol-gel process was progressed and a sulfonic acid group was introduced was formed. A thermal decomposition temperature of the product was 249° C. A conceivable structural formula of the product is as follows:

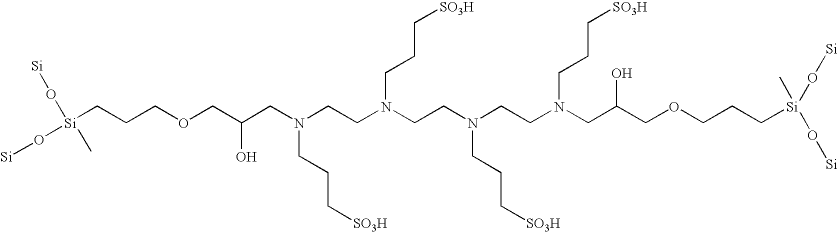

### Example 11

0.67 ml (4.0 mmol) of 3-aminopropyl trimethoxysilane and 0.88 ml (4.0 mmol) of 3-glycidyloxypropyl trimethoxysilane were weighed and put in a short-neck flask and, then, supplied with 12 ml of ethanol in an atmosphere of argon. The resultant solution was heated to 60° C. in an oil bath and, thereafter, stirred for 24 hours. The resultant reaction solution was supplied with 0.35 ml (4.0 mmol) of 1,3-propane sultone and stirred for 30 minutes and, then, further supplied with 0.43 ml (24 mmol) of distilled water and, then, stirred for 15 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. When the thus-obtained membrane was subjected to an IR measurement, since absorption peaks at 1168 cm⁻¹ and 1043 cm⁻¹ based on sulfonic acid and, further, an absorption peak at 1083 cm⁻¹ based on a siloxane bond were observed, it was confirmed that a structure in which a sol-gel process was progressed and a sulfonic acid group was introduced was formed. A thermal decomposition temperature of the product was 278° C. A conceivable structural formula of the product is as follows:

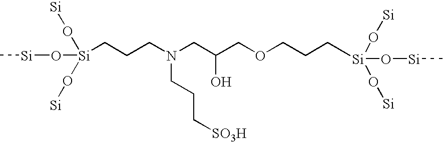

### Example 12

0.37 ml (2.5 mmol) of triethylene tetramine was weighed and put in a short-neck flask and, then, supplied with 7.5 ml of 2-propanol in an atmosphere of argon. The resultant solution was supplied with 1.1 ml (5.0 mmol) of 3-glycidyloxypropyl trimethoxysilane and, then, heated to 80° C. in an oil bath and, thereafter, stirred for 23 hours. Thereafter, the resultant reaction solution was supplied with 0.88 ml (10 mmol) of 1,3-propane sultone and, then, stirred for 15 minutes (solution 1). On the other hand, 0.56 ml (2.5 mmol) of tetraethyl orthosilicate was supplied with 2.5 ml of 2-propanol and 175 μl of 1 mol/L hydrochloric acid aqueous solution and, then, heated to 80° C. in an oil bath and, thereafter, stirred for 2 hours (solution 2). The solution 2 was supplied with the solution 1 and, then, stirred for 15 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. When the thus-obtained membrane was subjected to an IR measurement, since absorption peaks at 1164 cm⁻¹ and 1042 cm⁻³ based on sulfonic acid and, further, an absorption peak at 1112 cm⁻¹ based on a siloxane bond were observed, it was confirmed that a structure in which a sol-gel process was progressed and a sulfonic acid group was introduced was formed. A thermal decomposition temperature of the product was 271° C. A conceivable structural formula of the product is as follows:

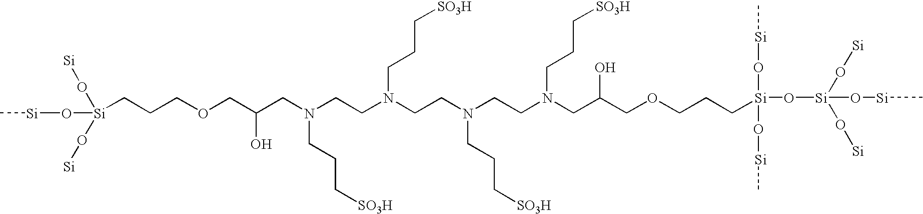

### Example 13

0.37 ml (2.5 mmol) of triethylene tetramine was weighed and put in a short-neck flask and, then, supplied with 7.5 ml of 2-propanol in an atmosphere of argon. The resultant solution was supplied with 1.1 ml (5.0 mmol) of 3-glycidyloxypropyl trimethoxysilane and, then, heated to 80° C. in an oil bath and, thereafter, stirred for 23 hours. Thereafter, the resultant reaction solution was supplied with 0.88 ml (10 mmol) of 1,3-propane sultone and, then, stirred for 15 minutes. The resultant reaction solution was supplied with 0.12 g of silica gel powder ground by an agate mortar and, then, stirred for 15 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellowish white membrane. When the thus-obtained membrane was subjected to an IR measurement, since absorption peaks at 1164 cm⁻¹ and 1042 cm⁻¹ based on sulfonic acid and, further, an absorption peak at 1112 cm⁻¹ based on a siloxane bond were observed, it was confirmed that a structure in which a sol-gel process was progressed and a sulfonic acid group was introduced was formed. A thermal decomposition temperature of the product was 252° C. A conceivable structural formula of the product is as follows:

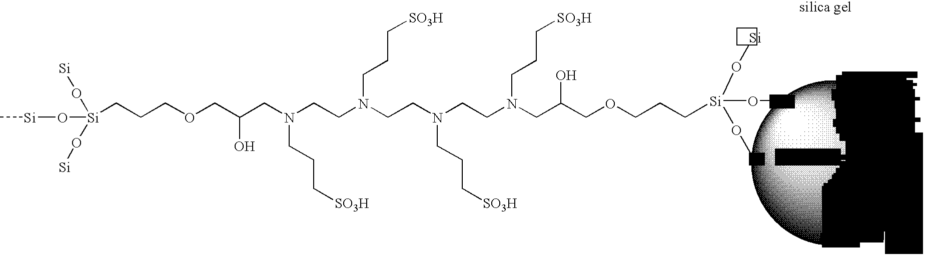

### Example 14

0.30 ml (2.0 mmol) of triethylene tetramine was weighed and put in a short-neck flask and, then, supplied with 6.0 ml of 2-propanol in an atmosphere of argon. The resultant solution was supplied with 0.88 ml (4.0 mmol) of 3-glycidyloxypropyl trimethoxysilane and, then, heated to 80° C. in an oil bath and, thereafter, stirred for 20 hours. Thereafter, the resultant reaction solution was supplied with 0.70 ml (8.0 mmol) of 1,3-propane sultone and, then, stirred for 15 minutes. To the resultant solution, 40 μl of 1 mol/L hydrochloric acid aqueous solution was added and, then, stirred for 10 minutes. Thereafter, the resultant mixture was extended in a flowing manner on a polystyrene casing having sizes of 5 cm×8.5 cm placed in a thermostat and, then, subjected to a thermal treatment for 12 hours at 60° C., to thereby obtain a soft yellow membrane. Thickness of the membrane was 230 μm. When the thus-obtained membrane was subjected to an IR measurement, since absorption peaks at 1198 cm⁻¹ and 1041 cm⁻¹ based on sulfonic acid and, further, an absorption peak at 1123 cm⁻³ based on a siloxane bond were observed, it was confirmed that a structure in which a sol-gel process was progressed and a sulfonic acid group was introduced was formed. A thermal decomposition temperature of the product was 262° C. A conceivable structural formula of the product is as follows:

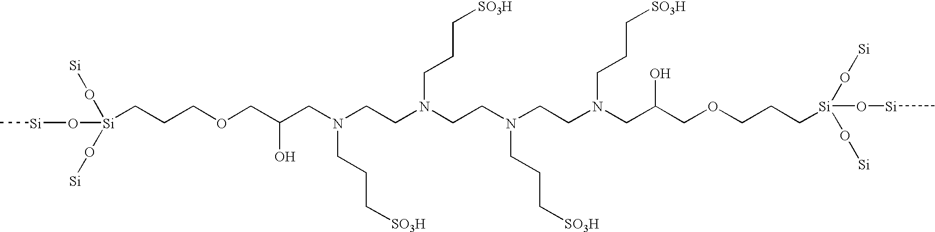

### Example 15

0.30 ml (2.0 mmol) of triethylene tetramine was weighed and put in a short-neck flask and, then, supplied with 6.0 ml of 2-propanol in an atmosphere of argon. The resultant solution was supplied with 0.88 ml (4.0 mmol) of 3-glycidyloxypropyl trimethoxysilane and, then, heated to 80° C. in an oil bath and, thereafter, stirred for 20 hours. Thereafter, the resultant reaction solution was supplied with 0.70 ml (8.0 mmol) of 1,3-propane sultone and, then, stirred for 15 minutes. To the resultant solution, 0.22 ml (12 mmol) of distilled water was added and, then, stirred for 20 minutes. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. Thickness of the membrane was 152 μm. When the thus-obtained membrane was subjected to an IR measurement, since absorption peaks at 1198 cm⁻¹ and 1042 cm⁻¹ based on sulfonic acid and, further, an absorption peak at 1123 cm⁻¹ based on a siloxane bond were observed, it was confirmed that a structure in which a sol-gel process was progressed and a sulfonic acid group was introduced was formed. A thermal decomposition temperature of the product was 235° C. A conceivable structural formula of the product is as follows:

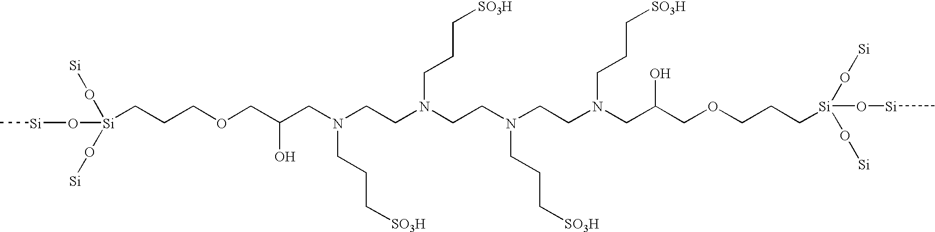

### Example 16

0.37 ml (2.5 mmol) of triethylene tetramine was weighed and, then, supplied with 7.5 ml of 2-propanol in an atmosphere of argon. The resultant solution was supplied with 1.1 ml (5.0 mmol) of 3-glycidyloxypropyl dimethoxymethylsilane and, then, heated to 80° C. in an oil bath and, thereafter, stirred for 27 hours. Thereafter, the resultant reaction solution was supplied with 0.88 ml (10 mmol) of 1,3-propane sultone and 0.18 ml (10 mmol) of distilled water and, then, further stirred for one hour. Thereafter, the resultant reaction solution was extended in a flowing manner on a polystyrene casing having sizes of 5 cm×8.5 cm placed in a thermostat and, then, subjected to a thermal treatment for 12 hours at 60° C., to thereby obtain a soft yellow membrane. The thus-obtained membrane was put in a polystyrene casing having sizes of 10 cm×10 cm in which a lower portion was filled with distilled water and, then, the casing was hermetically sealed and, thereafter, heated to 60° C. in a thermostat and, subsequently, left to stand still for 30 hours therein. When the thus-obtained membrane was subjected to an IR measurement, since absorption peaks at 1164 cm⁻¹ and 1041 cm⁻¹ based on sulfonic acid and, further, an absorption peak at 1089 cm⁻¹ based on a siloxane bond were observed, it was confirmed that a structure in which a sol-gel process was progressed and a sulfonic acid group was introduced was formed. A thermal decomposition temperature of the product was 249° C. A conceivable structural formula of the product is as follows:

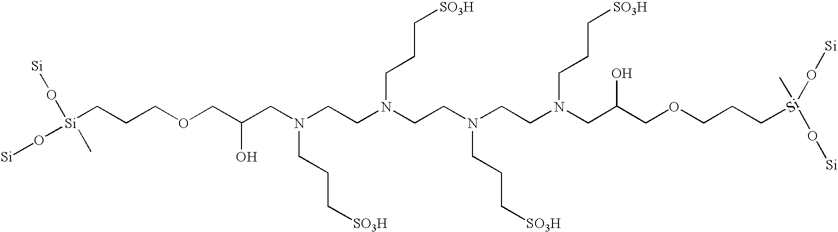

### Example 17

0.37 ml (2.5 mmol) of triethylene tetramine was weighed and, then, supplied with 17.5 ml of ethanol in an atmosphere of argon. The resultant solution was supplied with 1.1 ml (5.0 mmol) of 3-glycidyloxypropyl dimethoxymethylsilane and, then, heated to 80° C. in an oil bath and, thereafter, stirred for 24 hours. Thereafter, the resultant reaction solution was supplied with 0.88 ml (10 mmol) of 1,3-propane sultone and, then, further stirred for 15 minutes. Subsequently, 0.28 g of titanium oxide powder was added to the resultant solution with stirring and, immediately after the powder was dispersed therein, the resultant reaction solution was extended in a flowing manner on a polystyrene casing having sizes of 5 cm×8.5 cm placed in a thermostat and, then, subjected to a thermal treatment for 14 hours at 60° C., to thereby obtain a flexible soft slightly-yellowish membrane. When the thus-obtained membrane was subjected to an IR measurement, since absorption peaks at 1164 cm⁻¹ and 1037 cm⁻¹ based on sulfonic acid and, further, an absorption peak at 1098 cm⁻¹ based on a siloxane bond were observed, it was confirmed that a structure in which a sol-gel process was progressed and a sulfonic acid group was introduced was formed. A thermal decomposition temperature of the product was 275° C. A conceivable structural formula of the product is as follows:

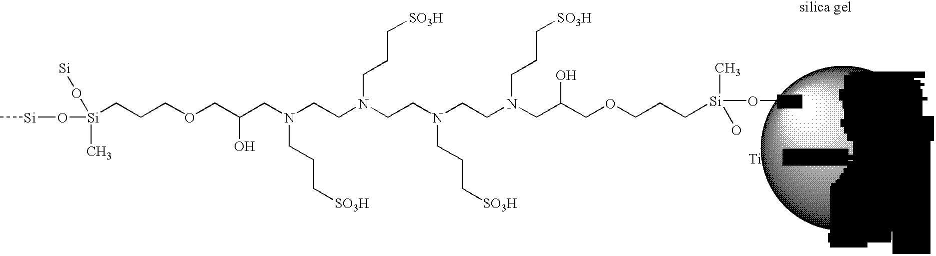

### Example 18

0.88 ml (5.0 mmol) of 3-aminopropyl trimethoxysilane and 0.85 ml (2.5 mmol) of 2,2-bis (4-glycidyloxyphenyl)propylidene were dissolved in 13 ml of ethanol in an atmosphere of argon and, then, stirred for 24 hours at 80° C. and, thereafter, supplied with 0.44 ml (5.0 mmol) of 1,3-propane sultone and, subsequently, further stirred for 15 minutes at 80° C. When 0.21 ml (0.50 mmol) of a 85% zirconium butoxide-1-butanol solution was added to the resultant solution, gelation was rapidly progressed. Thereafter, the resultant viscous solution was extended in a flowing manner on a polystyrene casing having sizes of 5 cm×8.5 cm placed in a thermostat and, then, subjected to a thermal treatment for 14 hours at 60° C., to thereby obtain an elastomeric colorless transparent membrane. Thickness of the membrane was 280 μm. When the thus-obtained membrane was subjected to an IR measurement, since absorption peaks at 1185 cm⁻¹ and 1038 cm⁻¹ based on sulfonic acid, an absorption peak at 1153 cm⁻¹ based on a siloxane bond and, further, an absorption peak at around 1018 cm⁻¹ based on an Si—O—Zr as a shoulder peak of an absorption peak at 1038 cm⁻¹ were observed, it was confirmed that a structure in which a sol-gel process was progressed and a sulfonic acid group was introduced was formed. A thermal decomposition temperature of the product was 299° C. A conceivable structural formula of the product is as follows:

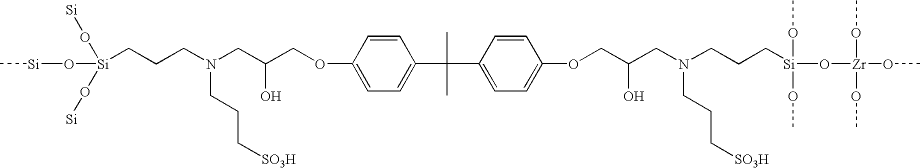

### Example 19

The organic-silica complex membrane having the sulfonic acid group obtained in each of Examples 3, 5, 6, 7, 12 and 18 was sandwiched by 2 pieces of gold electrodes and, then, conductivity thereof was measured by an AC impedance method. The results are shown in Table 1.

TABLE 1
<Conductivity of organic-silica complex membrane having sulfonic acid group>

| Example 3 | Example 5 | Example 6 | Example 7 | Example 12 | Example 18 |
|---|---|---|---|---|---|
| 90° C., | 90° C., | 90° C., | 90° C., | 80° C., | 90° C., |
| RH 90% | RH 90% | RH 80% | RH 70% | RH 70% | RH 100% |
| 1.12 × 10⁻⁷ S/cm | 6.05 × 10⁻⁷ S/cm | 8.11 × 10⁻⁴ S/cm | 1.64 × 10⁻⁶ S/cm | 6.85 × 10⁻⁴ S/cm | 6.98 × 10⁻⁴ S/cm |

Thus, the organic-silica complex membrane having the sulfonic acid group to be obtained according to the present invention showed characteristics as the electrolyte membrane.

### Example 20

When the organic-silica complex membrane obtained in Example 17 was dipped in a 0.4 g of methyl red-20 ml of acetone/water (volume ratio: 2/1) solution over night, the membrane was dyed red by absorbing the colorant. When the resultant membrane was left to stand under a low-pressure mercury lamp, it was discolored in about 15 minutes.

### Example 21

A letter was written on the organic-silica complex membrane obtained in Example 17 by using a blue marker. When the resultant membrane was left to stand for 8 hours in a sunny place outdoors in a clear day, the letter became unrecognizable.

### Comparative Example 1

A same treatment was conducted as in Example 20 except for using a paper filter in place of the organic-silica complex membrane. As a result, even when it is left to stand under the mercury lamp, discoloration thereof was not recognized in 8 hours.

### Comparative Example 2

A same treatment was conducted as in Example 21 except for using a polystyrene plate in place of the organic-silica complex membrane. As a result, even when it was left to stand under sunshine for 8 hours, the letter written on the polystyrene plate was substantially recognizable.

From Examples 20 and 21, and Comparative Examples 1 and 2, a catalytic action of decomposing by light an adsorbed material of the organic-silica complex membrane having the sulfonic acid group which has been doped with a metal oxide according to the present invention was confirmed.

1. A production method for an organic-silica complex membrane having a sulfonic acid group, being characterized by comprising the steps of:
obtaining a sulfonic acid derivative by allowing an alkoxysilane compound having an amino group to react with a cyclic sultone; and
subjecting the sulfonic acid derivative to a condensation reaction.

2. A production method for an organic-silica complex membrane having a sulfonic acid group, being characterized by comprising the steps of:
obtaining a sulfonic acid derivative by allowing a secondary or tertiary amine derivative which is obtained by allowing an alkoxysilane compound having an amino group to react with a compound having at least 2 epoxy groups in a molecule to react with a cyclic sultone; and
subjecting the sulfonic acid derivative to a condensation reaction.

3. A production method for an organic-silica complex membrane having a sulfonic acid group, being characterized by comprising the steps of:
obtaining a sulfonic acid derivative by allowing a secondary or tertiary amine derivative which is obtained by allowing an alkoxysilane compound having an epoxy group to react with an amine compound having at least 2 amine valences (number of hydrogen atoms originated in an amino group contained in one molecule) to react with a cyclic sultone; and
subjecting the sulfonic acid derivative to a condensation reaction.

4. A production method for an organic-silica complex membrane having a sulfonic acid group, being characterized by comprising the steps of:
obtaining a sulfonic acid derivative by allowing a secondary or tertiary amine derivative which is obtained by allowing an alkoxysilane compound having an amino group to react with an alkoxysilane compound having an epoxy group to react with a cyclic sultone; and
subjecting the sulfonic acid derivative to a condensation reaction.

5. The production method as set forth in claim 1, 2 or 4, wherein the alkoxysilane compound having an amino group is represented by the following general formulae (1) to (5): 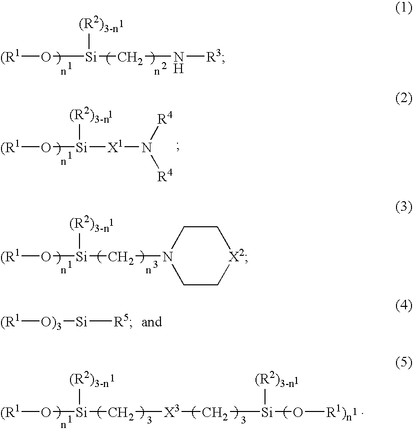
wherein R¹ represents a methyl group or an ethyl group;
R² represents a hydrogen atom, a methyl group or an ethyl group;
R³ represents a hydrogen atom, a methyl group, an ethyl group, an ally group, a phenyl group or an organic group represented by the following general formula (6);
R⁴ represents a methyl group, an ethyl group or a hydroxyethyl group;
R⁵ represents a 3-(N-phenylamino)propyl group, a 3-(4,5-dihydroimidazolyl)propyl group or a 2-[N-(2-aminoethyl)aminomethyl phenyl]ethyl group;
X¹ represents a divalent alkylene having from 1 to 6 carbon atoms;
X² represents methylene which is a divalent organic group, oxygen or a secondary amine;
X³ represents a divalent organic group represented by —NH— or —NHCH₂CH₂NH—;
n¹ represents an integer of from 1 to 3;
n² represents an integer of from 1 to 6; and
n³ represents an integer of from 1 to 3: 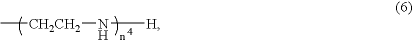
wherein n⁴ represents an integer of from 0 to 2.

6. The production method as set forth in claim 2, wherein the compound having at least 2 epoxy groups in a molecule is represented by the following general formulae (7) to (28): 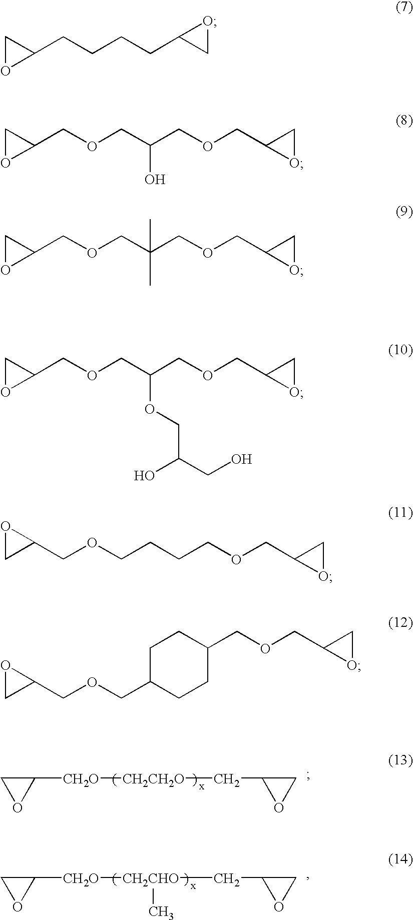
wherein x represents an integer of from 1 to 1000; 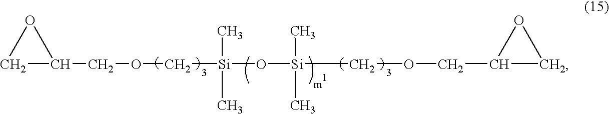
wherein m¹ represents an integer of from 1 to 100; 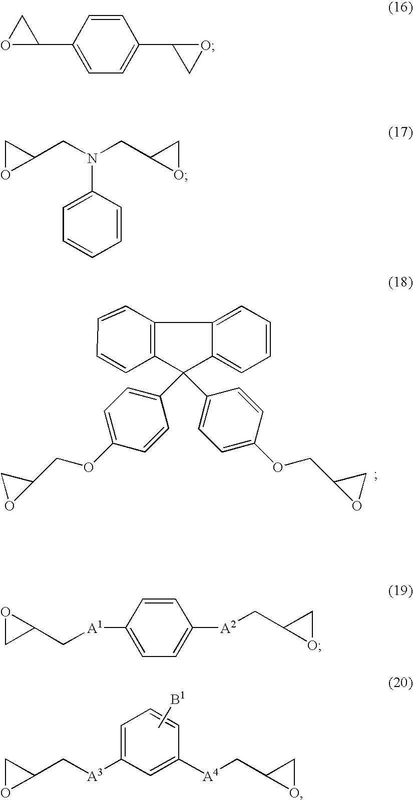
wherein A¹, A², A³ and A⁴ each independently represents a divalent linking group selected from among —O—, —C(═O)O—, —NHC(═O)O— and —OC(═O)O—; and
B¹ represents any one of substituents: —H, —CH₃ and —OCH₃; 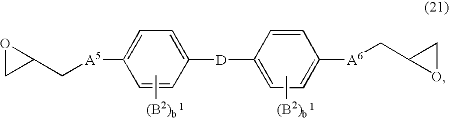
wherein A⁵ and A⁶ each independently represent a divalent linking group selected from among —O—, —C(═O)O—, —NHC(═O)O— and —OC(═O)O—;
B² represents any one of substituents: —H, —CH₃ and —OCH₃;
b¹ represents an integer of from 0 to 4;
D represents a single bond or any one of divalent linking groups: —O—, —C(═O)—, —C(═O)O—, —NHC(═O)—, —NH—, —N═N—, —CH═N—, —CH═CH—, —C(CN)═N—, —C≡C—, —CH₂—, —CH₂CH₂—, —CH₂CH₂CH₂—, C(CH₃)₂— and the general formulae: —O—(CH₂)ₘ—O— and —O— (CH₂CH₂O)ₙ—,
wherein m represents an integer of from 2 to 12; and
n represents an integer of from 1 to 5; 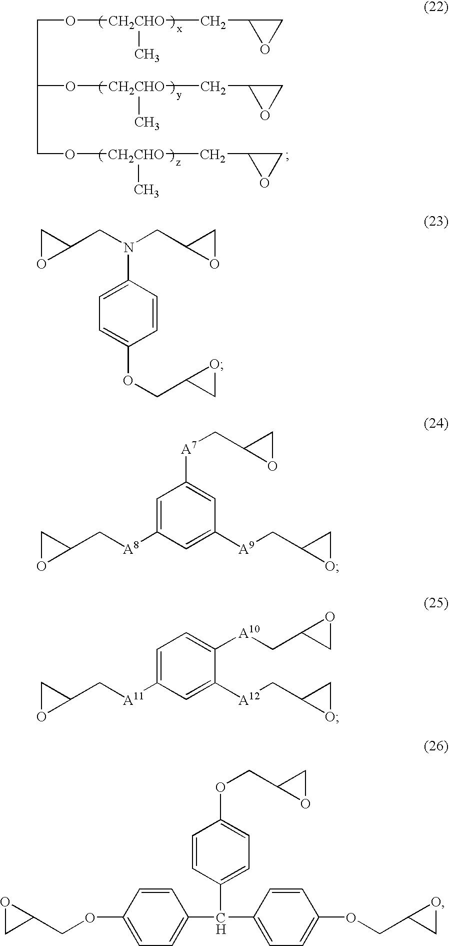
wherein x, y and z each independently represent an integer of from 1 to 20;
A⁷, A⁸ and A⁹ each independently represents a divalent linking group selected from among —O—, —C(═O)O—, —NHC(═O)O—, and —OC(═O)O—; and
A¹⁰, A¹¹ and A¹² each independently represents a divalent linking group selected from among —O—, —C(═O)O—, —NHC(═O)O— and —OC(═O)O—; 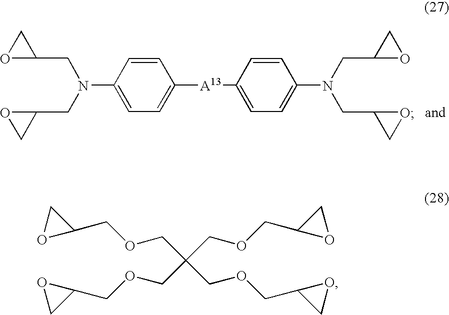
wherein A¹³ represents methylene or a linking group represented by any one of the following general formulae (29) and (30): 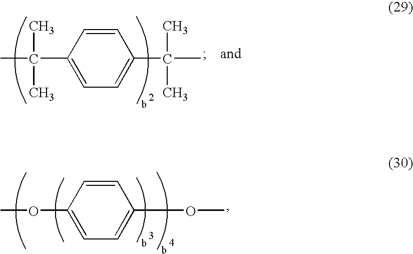
wherein b² represents an integer of from 0 to 4;
b³ represents an integer of from 1 to 3; and
b⁴ represents an integer of from 0 to 2.

7. The production method as set forth in claim 3 or 4, wherein the alkoxysilane compound having an epoxy group is represented by the following general formula (31) or (32): 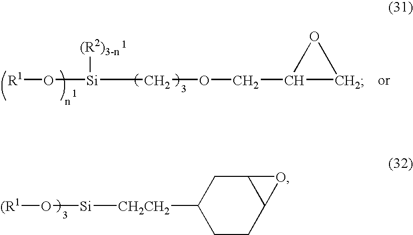
where in R¹ and R² each independently represents a methyl group or an ethyl group; and
n¹ represents an integer of from 1 to 3.

8. The production method asset forth in claim 3, wherein the amine compound having at least 2 amine valences is represented by the following general formulae (33) to (51): 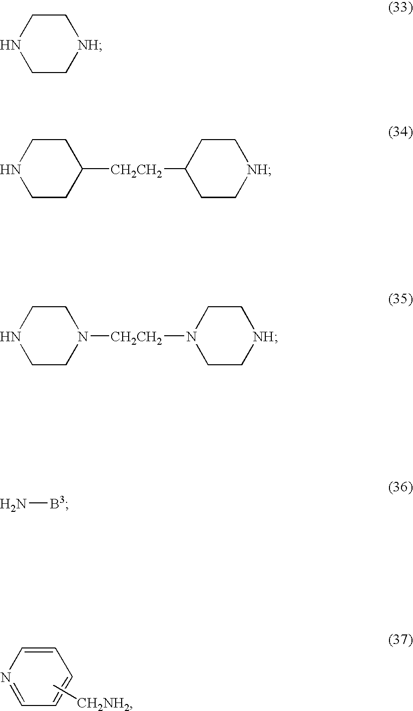
wherein B³ represents a hydrocarbon group having from 2 to 18 carbon atoms or a group having at least one ether bond in a hydrocarbon chain; 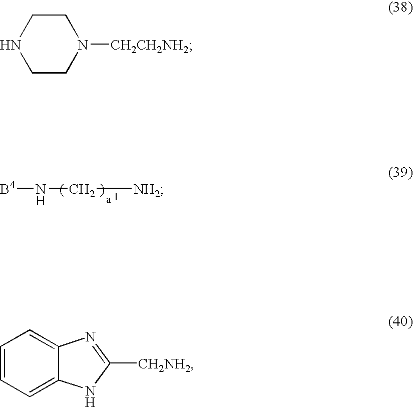
wherein a¹ represents an integer of from 2 to 18;
B⁴ represents a hydrocarbon group having from 1 to 18 carbon atoms or a group having at least one ether bond in a hydrocarbon chain; 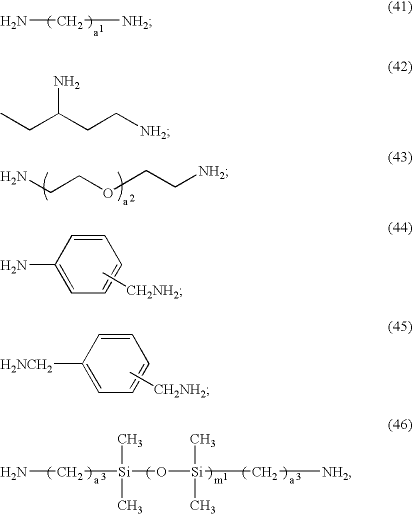
wherein a¹ represents an integer of from 2 to 18;
a² represents an integer of from 1 to 10000;
m¹ represents an integer of from 1 to 100; and
a³ represents an integer of from 3 to 18; 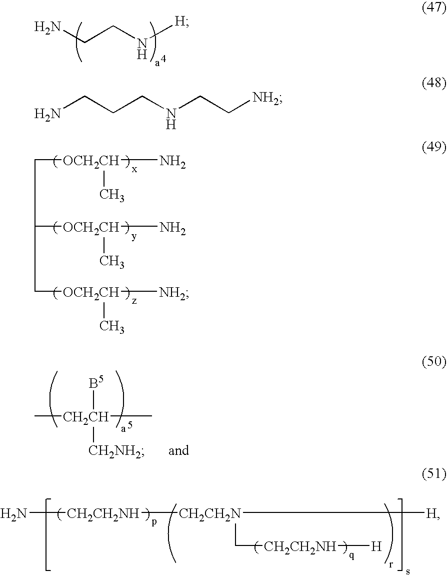
wherein a⁴ represents an integer of from 2 to 100;
x, y and z each independently represents an integer of from 1 to 20;
a⁵ represents an integer of from 2 to 1000;
B⁵ represents hydrogen or a methyl group; and
p, q, r and s each independently represents an integer of from 1 to 20.

9. The production method as set forth in any one of claims 1 to 8, wherein the cyclic sultone is represented by the following general formula (52) or (53):

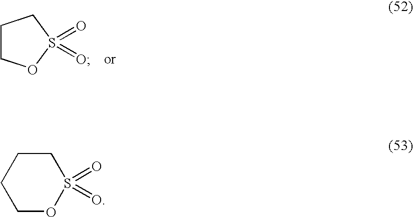

10. The production method as set forth in any one of claims 1 to 9, being characterized in that a condensation reaction of an alkoxysilane portion of the sulfonic acid derivative is progressed by a catalytic action of an self-sulfonic acid group of the sulfonic acid derivative generated by allowing to react with a cyclic sultone.

11. The production method as set forth in any one of claims 1 to 10, being characterized in that the step for obtaining the sulfonic acid derivative and the condensation reaction step are simultaneously progressed.

12. The production method as set forth in any one of claims 1 to 11, being characterized in that the condensation reaction step is performed in the presence of a metal alkoxide having no reactivity with an epoxy group and an amino group.

13. The production method as set forth in claim 12, wherein the metal alkoxide is represented by the following general formulae (54) to (61): 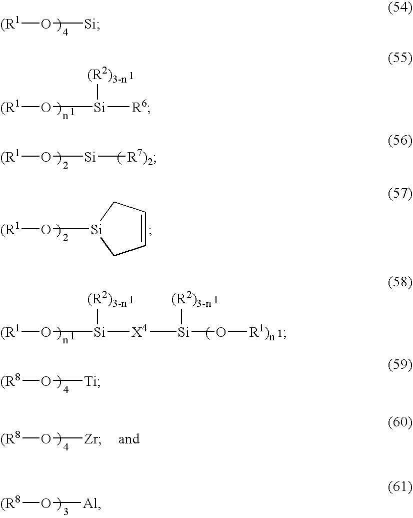
wherein R¹ and R² each independently represents a methyl group or an ethyl group;
R⁶ represents an alkyl group or alkenyl group having from 1 to 18 carbon atoms, a 2-cyanoethyl group, a 3-cyanopropyl group, a cyclohexyl group, a 2-(3-cyclohexenyl)ethyl group, 3-cyclopentadienyl propyl group, a phenyl group, a toluyl group or a monovalent organic group having a quaternary ammonium group represented by the following general formula (62);
R⁷ represents a cycloalkyl group or cycloalkenyl group having 5 or 6 carbon atoms;
R⁸ represents an alkyl group or alkenyl group having from 1 to 4 carbon atoms;
X⁴ represents a single bond, oxygen, an alkylene group having from 1 to 9 carbon atoms, a vinylene group or a divalent organic group represented by the following general formula (63) to (65); and
n¹ represents an integer of from 1 to 3: 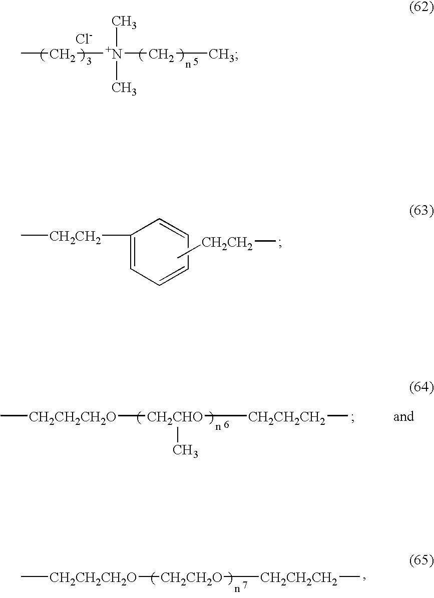
wherein n⁵ represents an integer of from 0 to 13;
n⁶ represents an integer of from 1 to 10; and
n⁷ represents an integer of from 0 to 20.

14. The production method as set forth in any one of claims 1 to 13, being characterized in that the condensation reaction step is performed in the presence of a metal oxide.

15. The production method as set forth in any one of claims 1 to 14, being characterized in that the condensation reaction step is performed in the presence of an acid or an alkali.

16. The production method as set forth in any one of claims 1 to 15, wherein the condensation reaction step is performed in an atmosphere of steam, an acidic or basic gas, and/or under a reduced pressure.

17. An organic-silica complex membrane, being obtained by the production method as set forth in any one of claims 1 to 16.

18. A production method for an organic-silica complex membrane having a free sulfonic acid group in the complex membrane, being characterized in that the complex membrane as set forth in claims 17 is dipped in a solvent containing an inorganic acid and/or an organic acid.

19. A production method for an organic-silica complex membrane having a free sulfonic acid group in the complex membrane, being characterized in that the complex membrane as set forth in claim 17 is dipped in a solvent containing at least one type selected from the group consisting of: methyl sulfate, dimethyl sulfate, an alkyl halide having from 1 to 10 carbon atoms and an allyl halide having from 1 to 10 carbon atoms.

20. An organic-silica complex membrane, being obtained by the production method as set forth in claim 18 or 19.

21. An electrolyte membrane, being characterized by comprising the organic-silica complex membrane as set forth in claim 17 or 20.

22. An electrolyte membrane, being obtained by dipping the organic-silica complex membrane as set forth in claim 17 or 20 in a solvent containing a lithium ion.

23. An electrochemical device, being characterized by comprising the electrolyte membrane as set forth in claim 21 or 22.

24. A membrane transfer device, being characterized by comprising the organic-silica complex membrane as set forth in claim 17 or 20.

25. A membrane reaction device, being characterized by comprising the organic-silica complex membrane as set forth in claim 17 or 20.
